(19) United States
(12) Patent Application Publication
(10) Pub. No.: US 2021/0388278 A1
(43) Pub. Date: Dec. 16, 2021

(54) A PROCESS FOR PRODUCING SYNTHETIC JET FUEL

(71) Applicant: GREENFIELD GLOBAL INC., Toronto (CA)

(72) Inventors: Arno DE KLERK, Edmonton (CA); Ranjit SEHDEV, Markham (CA); Richard Romeo LEHOUX, Windsor (CA)

(21) Appl. No.: 17/426,433

(22) PCT Filed: Jan. 30, 2020
(86) PCT No.: PCT/CA2020/050111

§ 371 Date: Jul. 28, 2021

Related U.S. Application Data
(60) Provisional application No. 62/798,636, filed on Jan. 30, 2019.

(51) Int. Cl. C10J 3/78; C10G 2/00; C10K 3/04; C10K 3/00; C10G 45/06; C10G 47/14

(52) U.S. Cl. CPC C10J 3/78; C10G 2/332; C10G 2/50; C10K 3/04; C10K 3/006; C10G 45/06; C10J 2300/0946; C10J 2300/1659; C10J 2300/0916; C10J 2300/0973; C10G 2400/00; C10G 2300/1011; C10G 2300/1003; C10G 47/14

(57) ABSTRACT

There is described a process for producing a semi-synthetic jet fuel, a fully synthetic jet fuel, or a combination of both, by converting feedstock into hydrocarbons.

### CROSS REFERENCE TO RELATED APPLICATION

This application claims priority to U.S. Provisional patent application No. 62/798,636, filed Jan. 30, 2019, the entire contents of which is hereby incorporated by reference.

### FIELD

The present disclosure relates generally to processes for producing jet fuels. More particularly, the present disclosure relates to a process for producing synthetic jet fuel.

### BACKGROUND

A process to produce aviation turbine fuel, also referred to as jet fuel, from feedstocks, such as renewable biomass and/or waste feedstocks is of value. Jet fuel is the least likely of the transportation fuels to be replaced by non-hydrocarbon based fuels, such as electricity.

There are challenges in devising a process to produce jet fuel from feedstocks such as renewable and/or waste materials.

A challenge is that of feed logistics related to biomass-to-liquids conversion; for example, as outlined in literature (Zwart, R. W. R.; Boerrigter, H.; Van der Drift, A. Energy Fuels 2006, 20, 2192-2197). Biomass as a representative feedstock is comprised mainly of lignocellulosic matter, and is a raw material that has to be collected over a wide area. Biomass has a low physical density, i.e. in mass per volume, and a low energy density, i.e. combustion energy per volume. Having a centralized processing facility to convert the biomass into jet fuel is typically preferred, but transporting such a low density raw material over large distances can be costly (e.g., both financially and energy-wise), and densification of the biomass before transport is generally required. Feed logistics can be less of a challenge with waste feedstocks, where the collection of waste is normally provided as a service to residents in a community through the sewage system and municipal waste (garbage) collection system.

Another challenge, related to feed logistics, is high water content of feedstocks, such as biomass and waste feedstocks. Although methods for drying and other forms of water removal are known (for example, Allardice, D. J.; Caffee, A. L.; Jackson, W. R.; Marshall, M. In Advances in the science of Victorian brown coal; Li, C-Z. Ed. Elsevier, 2004, p. 85-133), reducing water content to increase energy density can add cost.

Another challenge is feed heterogeneity. With feedstocks that are mainly solid in nature, heterogeneity generally refers to both physical and chemical diversity. When a process is sensitive to feed variation, effort must be expended to homogenize the feedstock, which adds cost.

Another challenge is related to molar ratios of hydrogen, carbon, and oxygen in feedstocks, such as biomass and waste feedstocks. Biomass and waste feedstocks contain oxygen-containing compounds where more than ⅓^{rd} the total mass can be oxygen. This is contrary to fossil crude feedstocks contain little oxygen. When such oxygen-containing feedstocks are converted to jet fuel, the oxygen is generally eliminated with either loss of hydrogen as water, or with loss of carbon as carbon monoxide or carbon dioxide. Jet fuel specifications, however, generally require near complete deoxygenation. Generally, biomass and bio-waste feedstocks generally have a hydrogen-to-carbon molar ratio of about 1.4 to 1, while jet fuel generally requires a higher hydrogen-to-carbon molar ratio of about 2 to 1, a consequence of jet fuel specifications such as smoke point and gravimetric energy density.

Another challenge is related to techniques for refining a biocrude product containing oxygen-containing compounds (oxygenates); for example when present in the <350° C. boiling fraction of the product. Experimental investigations that evaluated operation of petroleum refining technology with oxygenate-containing products indicated that modification of petroleum refining technology is often required, even for hydroprocessing; for example, Leckel, D. O. Energy Fuels 2007, 21, 662-667; Cowley, M. Energy Fuels 2006, 20, 1771-1776; Smook, D.; De Klerk, A. Ind. Eng. Chem. Res. 2006, 45, 467-471. The impact of oxygenates on catalysts and catalysis for refining has been reviewed (for example, De Klerk, A.; Furimsky, E. Catalysis in the refining of Fischer-Tropsch syncrude; Royal Society of Chemistry, 2010). Conventional refineries would likely have to undergo changes in order to utilize biocrude as a feedstock for jet fuel.

### SUMMARY

In an aspect of the present disclosure, there is provided a process for producing synthetic jet fuel, comprising converting feedstock to synthesis gas; converting the synthesis gas into a mixture comprising liquid hydrocarbons; refining the mixture comprising liquid hydrocarbons to isolate a kerosene product; and hydrotreating the kerosene product to form synthetic jet fuel.

In an embodiment of the present disclosure, there is provided a process wherein converting feedstock to synthesis gas comprises: pyrolyzing the feedstock under aqueous conditions to form a mixture comprising biocrude.

In another embodiment, there is provided a process wherein the feedstock comprises biomass, organic materials, waste streams, or a combination thereof with a high water content.

In another embodiment, there is provided a process wherein converting feedstock to synthesis gas comprises: pyrolyzing the feedstock to form a mixture comprising biocrude.

In another embodiment, there is provided a process wherein the feedstock comprises biomass, organic materials, waste streams, or a combination thereof with a low water content.

In another embodiment, there is provided a process wherein converting feedstock to synthesis gas further comprises: gasifying the mixture comprising biocrude to form the synthesis gas.

In another embodiment, there is provided a process wherein gasifying the mixture comprising biocrude comprises: supercritical water gasification of the mixture comprising biocrude to form a mixture comprising CH₄, CO, CO₂, and Hz; and reforming the mixture comprising CH₄, CO, CO₂, and H₂ to form the synthesis gas.

In another embodiment, there is provided a process wherein reforming comprises dry reformation and steam reformation.

In another embodiment, there is provided a process wherein when converting feedstock to synthesis gas, the process further comprises: adding an oil feedstock, a sugar feedstock, and/or an alcohol feedstock to the mixture comprising biocrude before gasifying.

In another embodiment, there is provided a process wherein the synthesis gas comprises a H₂ to CO ratio that is less than 2 to 1.

In another embodiment, there is provided a process wherein the synthesis gas comprises a stoichiometric ratio of (H₂—CO₂)/(CO+CO₂) that is less than 2 to 1.

In another embodiment, there is provided a process wherein the synthesis gas comprises a Ribblet ratio of (H₂)/(2CO+3CO₂), that is less than 1 to 1.

In another embodiment, there is provided a process wherein converting the synthesis gas into a mixture comprising liquid hydrocarbons comprises: performing a Fischer-Tropsch synthesis to convert the synthesis gas into a mixture comprising liquid hydrocarbons.

In another embodiment, there is provided a process wherein the Fischer-Tropsch synthesis is performed with an iron-based catalyst.

In another embodiment, there is provided a process wherein when performing the Fischer-Tropsch synthesis to convert the synthesis gas into a mixture comprising liquid hydrocarbons, the process further comprises: a water-gas shift reaction to increase concentration of H₂.

In another embodiment, there is provided a process wherein the Fischer-Tropsch synthesis is performed at a pressure of approximately 2 MPa; or at a pressure of greater than 2 MPa; or approximately 2.5 MPa; or approximately 2.8 MPa.

In another embodiment, there is provided a process wherein the Fischer-Tropsch synthesis is performed at a pressure in a range of about 1.5 MPa to 5 MPa; or in a range of about 2 MPa to about 4 MPa; or in a range of about 2 MPa to about 3 MPa; or in a range of about 1.5 to about 2.5 MPs; or in a range of about 2 MPa to about 2.5 MPa.

In another embodiment, there is provided a process wherein the Fischer-Tropsch synthesis is performed at a pressure of greater than 2 MPa.

In another embodiment, there is provided a process wherein the mixture comprising liquid hydrocarbons comprises an alkene to alkane ratio that is great than 1 to 1.

In another embodiment, there is provided a process wherein refining the mixture comprising liquid hydrocarbons to isolate a kerosene product comprises: performing a vapour-liquid equilibrium separation on the mixture comprising liquid hydrocarbons; and separating the mixture into the kerosene product and at least one of an aqueous product, a naphtha and gas product, or a gas oil and heavier product.

In another embodiment, there is provided a process wherein the vapour-liquid equilibrium separation is performed as a single-stage separation and/or a multi-stage separation.

In another embodiment, there is provided a process wherein when an aqueous product is separated, refining the mixture comprising liquid hydrocarbons to isolate a kerosene product further comprises: adding the separated aqueous product to the mixture comprising biocrude before gasifying the mixture comprising biocrude when converting feedstock to synthesis gas.

In another embodiment, there is provided a process wherein, when a naphtha and gas product is separated, refining the mixture comprising liquid hydrocarbons to isolate a kerosene product further comprises: oligomerizing the naphtha and gas product to form a mixture comprising a first additional kerosene product.

In another embodiment, there is provided a process wherein oligomerizing the naphtha and gas product is performed at a pressure of approximately 2.5 MPa; or approximately 2 MPa.

In another embodiment, there is provided a process wherein oligomerizing the naphtha and gas product is performed at a pressure in a range of about 1.5 MPa to 3 MPa; or in a range of about 1.5 MPa to about 2.5 MPa; or in a range of about 2 MPa to about 2.5 MPa.

In another embodiment, there is provided a process wherein oligomerizing the naphtha and gas product is performed with a non-sulfided catalyst.

In another embodiment, there is provided a process wherein oligomerizing the naphtha and gas product is performed with an acidic ZSM-5 zeolite catalyst.

In another embodiment, there is provided a process wherein the first additional kerosene product comprises alkene and aromatic compounds.

In another embodiment, there is provided a process wherein the first additional kerosene product comprises approximately 0% to approximately 60% aromatic compounds; approximately 1% to approximately 60% aromatic compounds; or approximately 1% to approximately 50% aromatic compounds; or approximately 1% to approximately 40% aromatic compounds; or approximately 1% to approximately 30% aromatic compounds; or approximately 0% to approximately 1% aromatic compounds; or approximately 1% to approximately 7% aromatic compounds; or approximately 8% to approximately 25% aromatic compounds; or approximately 8% aromatic compounds.

In another embodiment, there is provided a process wherein, when a gas oil and heavier product is separated, refining the mixture comprising liquid hydrocarbons to isolate a kerosene product further comprises: hydrocracking the gas oil and heavier product to form a mixture comprising a second additional kerosene product.

In another embodiment, there is provided a process wherein hydrocracking the gas oil and heavier product is performed at a pressure of approximately 2.5 MPa; or approximately 2 MPa.

In another embodiment, there is provided a process wherein hydrocracking the gas oil and heavier product is performed at a pressure in a range of about 1.5 MPa to 3 MPa; or in a range of about 1.5 MPa to about 2.5 MPa; or in a range of about 2 MPa to about 2.5 MPa.

In another embodiment, there is provided a process wherein hydrocracking the gas oil and heavier product is performed with a non-sulfided catalyst.

In another embodiment, there is provided a process wherein the hydrocracking is performed with a noble metal catalyst supported on amorphous silica-alumina. In another embodiment, the catalyst is Pt/SiO₂—Al₂O₃.

In another embodiment, there is provided a process wherein hydrotreating the kerosene product to form synthetic jet fuel comprises: hydrotreating the kerosene product, and when a naphtha and gas product is separated, hydrotreating the first additional kerosene product, to form a mixture comprising paraffinic hydrocarbons; and fractionating the mixture comprising paraffinic hydrocarbons, and when a gas oil and heavier product is separated, fractionating the mixture comprising the second additional kerosene product, to isolate the synthetic jet fuel.

In another embodiment, there is provided a process wherein when fractionating the mixture comprising paraffinic hydrocarbons and fractionating the mixture comprising the second additional kerosene product, the process further comprises: adding the mixture comprising the second additional kerosene product to the mixture comprising paraffinic hydrocarbons before fractionating.

In another embodiment, there is provided a process wherein each of the kerosene product, the first additional kerosene product, and the second additional kerosene product have a normal boiling point temperature range of about 140° C. to about 300° C.

In another embodiment, there is provided a process wherein the hydrotreating is performed at a pressure of approximately 2.5 MPa; or approximately 2 MPa.

In another embodiment, there is provided a process wherein the hydrotreating is performed at a pressure in a range of about 1.5 MPa to 3 MPa; or in a range of about 1.5 MPa to about 2.5 MPa; or in a range of about 2 MPa to about 2.5 MPa.

In another embodiment, there is provided a process wherein the hydrotreating is performed with a non-sulfided catalyst.

In another embodiment, there is provided a process wherein the hydrotreating is performed with a reduced base metal catalyst supported on alumina or silica. In another embodiment, the catalyst is reduced Ni/Al₂O₃.

In another embodiment, there is provided a process wherein the synthetic jet fuel is a semi-synthetic jet fuel, a fully synthetic jet fuel, or a combination thereof.

### BRIEF DESCRIPTION OF THE FIGURES

Embodiments of the present disclosure will now be described, by way of example only, with reference to the attached Figures.

FIG. 1 depicts a block flow diagram of the herein described process. The steps are denoted by blocks with dashed lines and are numbered from 1 to 5. Within each of the dashed line blocks the next level of process detail is provided. Each major unit is numbered. Only streams were differentiation is needed to clarity are numbered.

FIG. 2 depicts a detailed block flow diagram of the third step and the fourth step of FIG. 1, with major streams identified.

FIG. 3 depicts oligomerization unit, unit 5.1 in FIG. 1, in more detail with major streams identified.

FIG. 4 depicts an expansion of FIG. 3 showing how the lightest product fraction from the oligomerization unit, which includes synthesis gas compounds, is further processed.

FIG. 5 depicts an expansion of FIG. 3 showing how yield of synthetic jet fuel can be increased.

FIG. 6 depicts hydrocracking unit, unit 5.2 in FIG. 1, in more detail with major streams identified where the hydrogen feed and hydrogen recycle is not shown.

FIG. 7 depicts hydrotreating unit, unit 5.3 in FIG. 1, in more detail with major streams identified, where the hydrogen feed and hydrogen recycle is not shown.

FIG. 8 depicts an expansion of FIG. 7 showing how the product from the hydrotreater is separated.

FIG. 9 depicts an example of a system for producing synthetic synthesis gas, where A depicts a hydrothermal liquefaction unit; B depicts a supercritical water gasification unit; C depicts a reformation unit; and X-X′ indicates feed-flow between A and B, and Z-Z′ indicates feed-flow between B and C.

### DETAILED DESCRIPTION

Generally, the present disclosure provides a process for producing synthetic jet fuel, comprising converting feedstock to synthesis gas; converting the synthesis gas into a mixture comprising liquid hydrocarbons; refining the mixture comprising liquid hydrocarbons to isolate a kerosene product; and hydrotreating the kerosene product to form synthetic jet fuel.

In an example of the present disclosure, there is provided a process wherein converting feedstock to synthesis gas comprises: pyrolyzing the feedstock under aqueous conditions to form a mixture comprising biocrude.

In another example, there is provided a process wherein the feedstock comprises biomass, organic materials, waste streams, or a combination thereof with a high water content.

In another example, there is provided a process wherein converting feedstock to synthesis gas comprises: pyrolyzing the feedstock to form a mixture comprising biocrude.

In another example, there is provided a process wherein the feedstock comprises biomass, organic materials, waste streams, or a combination thereof with a low water content.

In another example, there is provided a process wherein converting feedstock to synthesis gas further comprises: gasifying the mixture comprising biocrude to form the synthesis gas.

In another example, there is provided a process wherein gasifying the mixture comprising biocrude comprises: supercritical water gasification of the mixture comprising biocrude to form a mixture comprising CH₄, CO, CO₂, and H₂; and reforming the mixture comprising CH₄, CO, CO₂, and H₂ to form the synthesis gas.

In another example, there is provided a process wherein reforming comprises dry reformation and steam reformation.

In another example, there is provided a process wherein when converting feedstock to synthesis gas, the process further comprises: adding an oil feedstock, a sugar feedstock, and/or an alcohol feedstock to the mixture comprising biocrude before gasifying.

In another example, there is provided a process wherein the synthesis gas comprises a H₂ to CO ratio that is less than 2 to 1.

In another example, there is provided a process wherein the synthesis gas comprises a stoichiometric ratio of (H₂—CO₂)/(CO+CO₂) that is less than 2 to 1.

In another example, there is provided a process wherein the synthesis gas comprises a Ribblet ratio of (H₂)/(2CO+3CO₂), that is less than 1 to 1.

In another example, there is provided a process wherein converting the synthesis gas into a mixture comprising liquid hydrocarbons comprises: performing a Fischer-Tropsch synthesis to convert the synthesis gas into a mixture comprising liquid hydrocarbons.

In another example, there is provided a process wherein the Fischer-Tropsch synthesis is performed with an iron-based catalyst.

In another example, there is provided a process wherein when performing the Fischer-Tropsch synthesis to convert the synthesis gas into a mixture comprising liquid hydrocarbons, the process further comprises: a water-gas shift reaction to increase concentration of H₂.

In another example, there is provided a process wherein the Fischer-Tropsch synthesis is performed at a pressure of approximately 2 MPa; or at a pressure of greater than 2 MPa; or approximately 2.5 MPa; or approximately 2.8 MPa.

In another example, there is provided a process wherein the Fischer-Tropsch synthesis is performed at a pressure in a range of about 1.5 MPa to 5 MPa; or in a range of about 2 MPa to about 4 MPa; or in a range of about 2 MPa to about 3 MPa; or in a range of about 1.5 to about 2.5 MPs; or in a range of about 2 MPa to about 2.5 MPa.

In another example, there is provided a process wherein the Fischer-Tropsch synthesis is performed at a pressure of greater than 2 MPa.

In another example, there is provided a process wherein the mixture comprising liquid hydrocarbons comprises an alkene to alkane ratio that is great than 1 to 1.

In another example, there is provided a process wherein refining the mixture comprising liquid hydrocarbons to isolate a kerosene product comprises: performing a vapour-liquid equilibrium separation on the mixture comprising liquid hydrocarbons; and separating the mixture into the kerosene product and at least one of an aqueous product, a naphtha and gas product, or a gas oil and heavier product.

In another example, there is provided a process wherein the vapour-liquid equilibrium separation is performed as a single-stage separation and/or a multi-stage separation.

In another example, there is provided a process wherein when an aqueous product is separated, refining the mixture comprising liquid hydrocarbons to isolate a kerosene product further comprises: adding the separated aqueous product to the mixture comprising biocrude before gasifying the mixture comprising biocrude when converting feedstock to synthesis gas.

In another example, there is provided a process wherein, when a naphtha and gas product is separated, refining the mixture comprising liquid hydrocarbons to isolate a kerosene product further comprises: oligomerizing the naphtha and gas product to form a mixture comprising a first additional kerosene product.

In another example, there is provided a process wherein oligomerizing the naphtha and gas product is performed at a pressure of approximately 2.5 MPa; or approximately 2 MPa.

In another example, there is provided a process wherein oligomerizing the naphtha and gas product is performed at a pressure in a range of about 1.5 MPa to 3 MPa; or in a range of about 1.5 MPa to about 2.5 MPa; or in a range of about 2 MPa to about 2.5 MPa.

In another example, there is provided a process wherein oligomerizing the naphtha and gas product is performed with a non-sulfided catalyst.

In another example, there is provided a process wherein oligomerizing the naphtha and gas product is performed with an acidic ZSM-5 zeolite catalyst.

In another example, there is provided a process wherein the first additional kerosene product comprises alkene and aromatic compounds.

In another example, there is provided a process wherein the first additional kerosene product comprises approximately 0% to approximately 60% aromatic compounds; approximately 1% to approximately 60% aromatic compounds; or approximately 1% to approximately 50% aromatic compounds; or approximately 1% to approximately 40% aromatic compounds; or approximately 1% to approximately 30% aromatic compounds; or approximately 0% to approximately 1% aromatic compounds; or approximately 1% to approximately 7% aromatic compounds; or approximately 8% to approximately 25% aromatic compounds; or approximately 8% aromatic compounds.

In another example, there is provided a process wherein, when a gas oil and heavier product is separated, refining the mixture comprising liquid hydrocarbons to isolate a kerosene product further comprises: hydrocracking the gas oil and heavier product to form a mixture comprising a second additional kerosene product.

In another example, there is provided a process wherein hydrocracking the gas oil and heavier product is performed at a pressure of approximately 2.5 MPa; or approximately 2 MPa.

In another example, there is provided a process wherein hydrocracking the gas oil and heavier product is performed at a pressure in a range of about 1.5 MPa to 3 MPa; or in a range of about 1.5 MPa to about 2.5 MPa; or in a range of about 2 MPa to about 2.5 MPa.

In another example, there is provided a process wherein hydrocracking the gas oil and heavier product is performed with a non-sulfided catalyst.

In another example, there is provided a process wherein the hydrocracking is performed with a noble metal catalyst supported on amorphous silica-alumina. In another example, the catalyst is Pt/SiO₂—Al₂O₃.

In another example, there is provided a process wherein hydrotreating the kerosene product to form synthetic jet fuel comprises: hydrotreating the kerosene product, and when a naphtha and gas product is separated, hydrotreating the first additional kerosene product, to form a mixture comprising paraffinic hydrocarbons; and fractionating the mixture comprising paraffinic hydrocarbons, and when a gas oil and heavier product is separated, fractionating the mixture comprising the second additional kerosene product, to isolate the synthetic jet fuel.

In another example, there is provided a process wherein when fractionating the mixture comprising paraffinic hydrocarbons and fractionating the mixture comprising the second additional kerosene product, the process further comprises: adding the mixture comprising the second additional kerosene product to the mixture comprising paraffinic hydrocarbons before fractionating.

In another example, there is provided a process wherein each of the kerosene product, the first additional kerosene product, and the second additional kerosene product have a normal boiling point temperature range of about 140° C. to about 300° C.

In another example, there is provided a process wherein the hydrotreating is performed at a pressure of approximately 2.5 MPa; or approximately 2 MPa.

In another example, there is provided a process wherein the hydrotreating is performed at a pressure in a range of about 1.5 MPa to 3 MPa; or in a range of about 1.5 MPa to about 2.5 MPa; or in a range of about 2 MPa to about 2.5 MPa.

In another example, there is provided a process wherein the hydrotreating is performed with a non-sulfided catalyst.

In another example, there is provided a process wherein the hydrotreating is performed with a reduced base metal catalyst supported on alumina or silica. In another example, the catalyst is reduced Ni/Al₂O₃.

In another example, there is provided a process wherein the synthetic jet fuel is a semi-synthetic jet fuel, a fully synthetic jet fuel, or a combination thereof.

Before explaining the present invention in detail, it is to be understood that the invention is not limited to the exemplary embodiments contained in the present application. The invention is capable of other embodiments and of being practiced or carried out in a variety of ways. It is to be understood that the phraseology and terminology employed herein are for the purpose of description and not of limitation.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing an exemplary implementation of the various embodiments described herein.

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

As used herein, the terms “about” and “approximately” are used in conjunction with ranges of dimensions, concentrations, temperatures, or other physical or chemical properties and characteristics. Use of these terms is meant to cover slight variations that may exist in the upper and lower limits of the values or ranges of properties and characteristics, for example by ±10%, or ±5%.

As used herein, ‘aviation turbine fuel’ or ‘jet fuel’ refers to kerosene before addition of required fuel additives to meet specification requirements for synthetic aviation turbine fuel as either a jet fuel blend component with petroleum derived kerosene (i.e. semi-synthetic jet fuel), or a jet fuel without any petroleum derived kerosene (i.e. fully synthetic jet fuel). For example, these specification requirements are described in appropriate standards documents, such as the United Kingdom Ministry of Defense. Defense Standard 91-91, Issue 7. Turbine Fuel, Kerosine Type, Jet A-1, NATO Code: F-35, Joint Service Designation: AVTUR; Ministry of Defence: London, 18 Feb. 2011, and ASTM D 7566-15b updated to ASTM D 7566-19 (e.g., see Annex A1, synthesized paraffinic kerosene (SPK) with aromatics). Standard specification for aviation turbine fuel containing synthesized hydrocarbons; American Society for Testing and Materials: West Conshohocken, Pa., 2015. As a skilled person would recognize, only a few of the specification requirements may to be met by adding additives; many of the specification requirements may be met via the refining process (e.g., see Example 4 below, wherein it was possible to meet requirements after adding only a static dissipator).

As used herein, ‘feedstock’ refers to biomass, organic materials, waste streams, or combinations thereof. Examples of feedstocks includes but is not limited to a waste stream from a grain ethanol plant (bagasse, stillage, wastewater and glycerin), cellulosic biomass (wood, energy crops, grasses), organic wastes (green bin collection waste products; sewage sludge), agricultural wastes (agricultural plant wastes or residues, manure), pulp and paper plant waste streams (wood waste, prehydrolysate), municipal-sorted organic wastes, biodiesel (glycerin) and any combinations thereof. Examples of biomass include, but are not limited to materials that are by-products from activities such as forest harvesting, products manufacturing, construction, and demolition debris harvesting or management; and lignocellulosic biomass, for example wood based residues, which are classified into three categories: forest residues, urban residues, and mill residues. Examples of organic materials include, but are not limited to any one of cellulosic materials, lignocellulosic materials, wastes, such as wood processing wastes, agricultural residues, municipal green bin collections, manures, an effluent from a cellulosic material processing plant, an effluent from a paper plant, an effluent from an ethanol-from-biomass process, thin or whole stillage, dry distillers grains, and biodegradable waste waters; materials with carbon and hydrogen in its molecular structure, for example alcohols, ketones, aldehydes, fatty acids, esters, carboxylic acids, ethers, carbohydrates, proteins, lipids, polysaccharides, monosaccharide, cellulose, nucleic acids, etc.; and may be present for example, in waste (e.g. agricultural or industrial waste streams; sewage sludge), organic fluid streams, fresh biomass, pretreated biomass, partially digested biomass, etc. In some examples, ‘feedstock’ as defined herein includes feedstocks with a high water content and/or feedstocks with a low energy density. In some examples, ‘feedstock’ as defined herein includes feedstocks with a low water content.

In some examples, a high water content refers to a material having water present as a separate phase at ambient conditions. In an example, a high water content refers to a material with a water content that exceeds the organic matter content. In other examples, a high water content refers to a water content of, for example, >40 wt %, or, between about 50 wt % to about 95 wt %; or between about 60 wt % to about 90 wt %; or between about 70 wt % to about 90 wt %; or between about 80 wt % to about 90 wt %; or, any value between about 50 wt % and about 70 wt % to any value between about 75 wt % and about 95 wt %. In some examples, a low water content refers to a material without water present as a separate phase at ambient conditions. In other examples, a low water content refers to a water content of, for example, ≤40 wt %, or, between about 5 wt % to about 40 wt %; or between about 10 wt % to about 40 wt %; or between about 20 wt % to about 40 wt %; or between about 30 wt % to about 40 wt %; or, any value between about 5 wt % and about 20 wt % to any value between about 25 wt % and about 40 wt %.

As used herein, ‘oil feedstock’ refers to vegetable oils or animal fat oils. In some examples, ‘oil feedstock’ refers to waste vegetable oils or animal fat oils. ‘Sugar feedstock’ refers to solutions of sugar. In some examples, the sugar may be waste sugar. ‘Alcohol feedstock’ refers to liquid alcohols such as glycerol. In some examples, the liquid alcohol may be a waste alcohol.

As used herein, ‘pyrolyzing feedstock under aqueous conditions’ refers to pyrolysis or thermal treatment of feedstock in the presence of water present as a separate phase at ambient conditions; as such, but not limited to, hydrothermal liquefaction. As used herein, ‘pyrolyzing feedstock’ refers to pyrolysis or thermal treatment of feedstock where water is not present as a separate phase at ambient conditions. As would be recognized by a person of skill in the art, ‘aqueous conditions’ refer to water being present at an amount sufficient to act as, e.g., a reagent, catalyst, solvent, or combination thereof. As a skilled person would also recognize, ‘pyrolyzing conditions’ may refer to the absence of water; or to water being present at an amount that would not be sufficient for acting as, e.g., a reagent, catalyst, solvent, or combination thereof.

As used herein, ‘liquid hydrocarbons’ refers to linear, branched, and/or cyclic alkanes and alkenes (olefins), or aromatic compounds that may be unsubstituted or substituted with oxygen-containing functional groups, such as but not limited to alcohols, aldehydes, carboxylic acids, ketones, ethers, etc.

As used herein, ‘biocrude’ is a mixture that includes but is not limited to aromatic compounds, polyaromatic compounds, fatty acids, alkanes, alkenes, and/or oxygen-containing compounds.

As used herein, ‘paraffinic hydrocarbons’ refers to linear or branched alkanes, and may include cycloalkanes.

Described herein is a process that converts feedstocks, such as biomass, waste feedstocks, oil feedstocks, sugar feedstocks, and/or alcohol feedstock to a synthetic jet fuel that is suitable for blending, or for direct use as a semi-synthetic or fully synthetic jet fuel.

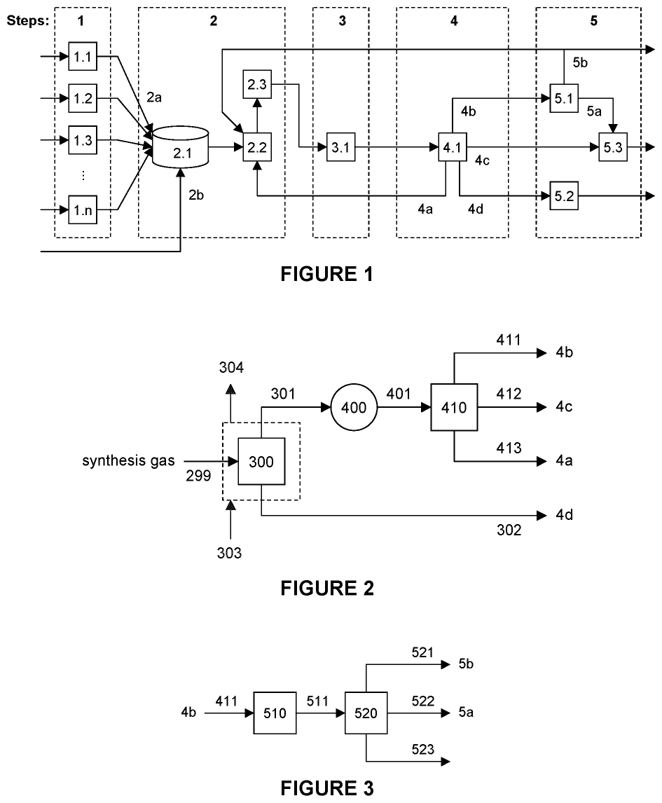

With reference to FIG. 1, an example of the process is described in five steps, as indicated by blocks with dashed lines. The five steps include (1) pyrolysis of feedstock, or pyrolysis of feedstock under aqueous conditions (e.g., hydrothermal liquefaction) to produce a mixture comprising bio-crude, (2) gasification of the mixture comprising biocrude to form synthesis gas, and optionally adding an oil feedstock, a sugar feedstock, and/or an alcohol feedstock to the mixture comprising biocrude before gasifying, (3) performing a Fischer-Tropsch synthesis to convert the synthesis gas into a mixture comprising liquid hydrocarbons, (4) refining the mixture comprising liquid hydrocarbons to isolate a kerosene product, and least three other fractions, and (5) hydrotreating the kerosene product to produce jet fuel as a major product. In some examples, step 1 of FIG. 1 is performed at distributed locations and steps 2 to 5 of FIG. 1 are performed in a central location.

Step 1 of FIG. 1 is directed towards converting feedstock, such as bulky low energy-density feedstocks, into a denser liquid that can be readily handled and transported. In an example of step 1, pyrolysis under aqueous conditions involves hydrothermal liquefaction, as depicted by block 1 in FIG. 1. As depicted, the hydrothermal liquefaction units are small-scale distributed units that can be deployed close to a feedstock source, such as a source of biomass or waste materials. The hydrothermal liquefaction units are represented by blocks 1.1 to 1.n in FIG. 1, where n is a positive integer value. By deploying direct liquefaction units in a distributed fashion, the distance from the raw feedstock to a central plant is reduced; and, since the product produced in step 1 (i.e., a mixture comprising biocrude) has a lower water content and higher physical density and energy density than the feedstock, this conversion can make transport to a large centralized final product factory viable. By producing a mixture comprising biocrude, which is a liquid product, it is relatively easier to homogenize than densified solid products. Optionally, one of the hydrothermal liquefaction units may be located at the central processing facility. In another example of step 1, not shown, other liquefaction technologies may be selected, as appropriate, for each of the distributed feedstocks, such as pyrolysis to produce oil from dry/solid-like feedstocks. In said example, the blocks 1.n of step 1 are pyrolysis units. When only a single localized feed source is available, then n=1 in FIG. 1 and only a single hydrothermal liquefaction unit is employed.

Hydrothermal liquefaction is a process whereby a feedstock is heated under aqueous conditions for a time period sufficient to substantially hydrolyze the feedstock and produce a liquefaction product that has lower average molecular mass than the feed. Hydrothermal liquefaction is an example of a direct liquefaction process. The hydrothermal liquefaction process may be implemented as a batch, semi-batch, or continuous process under subcritical or supercritical water conditions. The operating conditions, supercritical or subcritical, also dictate a minimization of char formation and oxygen contents in the liquefaction product. Some non-condensable gases produced during this process may be used as fuel gases to provide required energy. Hydrothermal liquefaction does not require the feedstock to be dried. Depending on the temperature to which the feedstock is heated, pressure will autogenously develop to limit vaporization of water. Subsequent to hydrothermal liquefaction, a liquid-liquid phase separation may be employed to separate water and liquefaction product. The hydrothermal liquefaction process can be implemented at small-scale to the extent that it can be implemented even on a mobile unit.

In an example of the process as described herein, hydrothermal liquefaction (HTL) is conducted at a temperature of about 350° C. for 40 minutes. Alternatively, it is conducted in supercritical water around 410° C. for only a few minutes (e.g., about 5 minutes or less). As a skilled person would recognize, different hydrothermal liquefaction conditions can create slight different biocrudes, a main difference being the amount of oxygen in the biocrudes: supercritical water HTL can produce biocrudes containing from about 8% to about 10% oxygen, while HTL pyrolysis can produce biocrudes containing oxygen in the low 40% range. The process as described herein can accept all different types of biocrudes/bio oils.

In one example, trailers with mobile liquefaction units (e.g., hydrothermal liquefaction units, or pyrolysis units, etc.) may be parked on farms to process farm waste and biomass to a liquefaction product (e.g., a mixture comprising biocrude) that is collected in a mobile tank for intermittent collection. Such mobile units would typically be designed for simple and unsupervised operation. In another example, larger stationary liquefaction units may be stationed at facilities, such as municipal waste handling facilities and saw or paper mills, where a collection network for biomass and waste feedstocks is already in place. These stationary liquefaction units would typically be designed with more complex heat integration for higher efficiency of operation due to their larger scale. The rest of the process is conducted at a central facility, where the liquefaction product (e.g., a mixture comprising biocrude) is collected from the distributed liquefaction units and processed.

Step 2 of FIG. 1 is directed towards combining and homogenizing the liquefaction product (i.e., the mixture comprising biocrude) (see unit 2.1 in FIG. 1) from step 1 (see 2a in FIG. 1), and potentially an oil feedstock, a sugar feedstock, and/or an alcohol feedstock from other sources than step 1, such as waste vegetable or animal fat oils (see 2b in FIG. 1), and then to gasify these feed materials to raw synthesis gas (see unit 2.2 in FIG. 1). As indicated in FIG. 1, the feed materials for the production of raw synthesis gas (in unit 2.2) may additionally include a Fischer-Tropsch aqueous product (stream 4a) and material from refining (stream 5b). The raw synthesis gas is then cleaned (see unit 2.3 in FIG. 1) to produce clean synthesis gas.

The term raw synthesis gas refers to a gas that includes a mixture of hydrogen (H₂) and carbon monoxide (CO), along with other compounds. The other compounds typically include, but are not limited to carbon dioxide (CO₂), water vapor (H₂O), and methane (CH₄). The term clean synthesis gas refers to raw synthesis gas after removal of potentially detrimental compounds that were present in the raw synthesis gas. The most common class of contaminants that must be removed is sulfur-containing compounds such as hydrogen sulfide (H₂S) and carbonyl sulfide (COS). Additionally other compounds may also be removed during cleaning to improve efficiency of downstream processes.

Employing a mixture comprising biocrude as a feed for raw synthesis gas production, as well as other liquid feeds, such as oil feedstocks, sugar feedstocks, and/or alcohol feedstocks, can reduce the impact of feed heterogeneity by blending in a feed tank (see unit 2.1 in FIG. 1) prior to gasification. Since the feed material is largely liquid, it is easier to homogenize feed materials from different sources. Further, a liquid feed can make producing a raw synthesis gas production relatively simpler and efficient, because it avoids solids handling; liquid feeds can be pumped to pressurize them; liquid feeds can have superior heat transfer properties for gasification; and when washed, it is void of minerals that can potentially contaminate the synthesis gas. Operating pressure of the raw synthesis gas generation step affects the downstream operation. It is of benefit to perform raw synthesis gas generation at an elevated pressure. In an example, raw synthesis gas is generated at pressure of about 2 MPa or higher; or in a range of about 2 MPa to 5 MPa; or in a range of about 2 MPa to about 4 MPa; or in a range of about 2 MPa to about 3 MPa.

In an example of the process as described herein, the raw synthesis gas is produced by supercritical water gasification (SCWG). With SCWG and the appropriate amount of water with respect to the carbon/hydrogen/oxygen content, heat required for the gasification is generated within a reactor by the SCWG exothermic reactions once the gasification has been started by an external heat source, such as a start-up furnace. As such, SCWG does not require a constant source of external heat, while excess water requires some external heat. Further, the SCWG reactor operates at a lower temperature, and without a need to employ an externally supplied oxidant. Water in the SCWG reactor gives up some of its hydrogen, typically through the water-gas shift reaction, to increase the hydrogen-to-carbon ratio in the raw synthesis gas above that generally anticipated from gasification of the liquid feeds alone. All feed materials are introduced into the SCWG process in the liquid phase at high pressure, generally above pressure requirements of a synthesis gas feed for a Fischer-Tropsch synthesis, which is both energy efficient, and less complex than compressing the raw synthesis gas after being produced. Hot gas coming out of the SCWG reactor exchanges heat with incoming feedstock, and water vapors in the gas are cooled/condensed along with other water soluble organic compounds, and separated in pressurized liquid/gas separators. Part of the separated water-rich product is recycled back into the SCWG process. At this point, the raw synthesis gas may still contain compounds other than hydrogen and carbon monoxide. Some of these compounds may be removed by condensation, but some gas cleaning (see unit 2.3 in FIG. 1) may be required to remove gaseous contaminants that could affect downstream processes. Cleaned synthesis gas may still contain compounds other than hydrogen and carbon monoxide, such as water vapor and carbon dioxide, but it would be substantially free from sulfur-containing compounds. Methods for cleaning the raw synthesis gas to obtain clean synthesis gas are known to persons skilled in the art.

In an example of the process as described herein, supercritical water gasification (SCWG) is conducted at a temperature in the range of 570° C. to 590° C., with a water content of about 30% to about 60%, and at a pressure in the range of about 20 MPa to about 30 MPa, or about 22.5 MPa to about 25 MPa. In another example, supercritical water gasification (SCWG) is conducted at a temperature of about >550° C., with the pressure being dependent on reactor design and means for pressure control.

In some examples of step 2, reforming is used in conjunction with clean synthesis gas production to convert hydrocarbons present in the clean synthesis gas to hydrogen and carbon monoxide. Presence of enough methane in raw synthesis gas, along with carbon dioxide, allow reformation of these gases using steam reforming and dry reforming. This also allows for recycling of additional CO₂ from the raw synthesis gas to maximize conversion of the methane into carbon monoxide and hydrogen. Some carbon dioxide and water is also produced in the formation processes. Water may be separated by cooling the gases, and carbon dioxide may be reduced in a synthesis gas clean up unit.

In its simplest form, the reactions of steam reforming and dry methane reforming, along with the water-gas shift and reverse water-gas shift reactions during step 2 are as follows:

CH₄+CO₂ [symbol] 2CO+2H₂ 1.

CH₄+2H₂O [symbol] CO+3H₂ 2.

CO₂+H₂ [symbol] CO+H₂O 3.

CO+H₂O [symbol] CO₂+H₂ 4.

Optionally, the use of a water-gas shift converter may be considered to change the molar ratio of hydrogen-to-carbon monoxide in the clean synthesis gas. At least some of the potential technologies that could be selected for step 3 may benefit from a hydrogen to carbon monoxide molar ratio that is closer to 2 to 1. Optionally, production of clean synthesis gas is followed by removal of some CO₂ from the clean synthesis gas. Part of the CO₂ could be recycled.

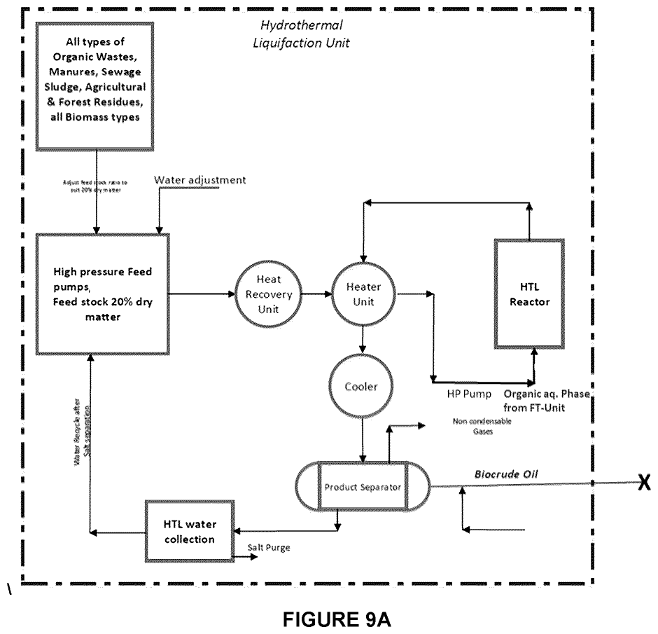

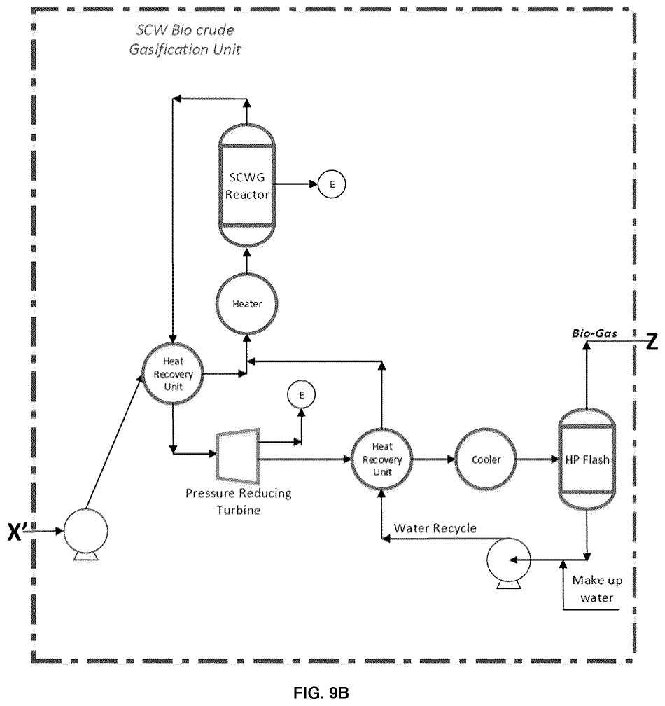

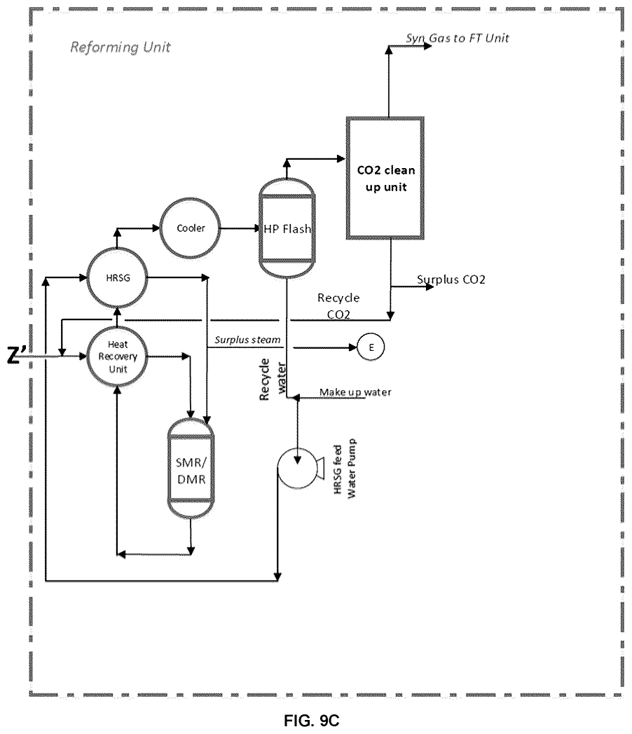

FIG. 9 depicts an example of a system for producing synthesis gas that can be used with the process as described herein, where A depicts a hydrothermal liquefaction unit; B depicts a supercritical water gasification unit; and C depicts a reformation unit.

More particularly, FIG. 9A depicts an example of a hydrothermal liquefaction (HTL) unit that involves:
Feedstock of all types, such as all types of organic wastes, manures, sewages sludge, agricultural and forest residues, and all biomass types;
Feedstock ratio adjustment to suit 20% dry matter, with possible water adjustment;
Feedstock (20% dry matter) pumped via high pressure feed pump to a heat recovery unit, and then pumped to a heater unit;
Feed, which may include an organic/aqueous phase from a Fischer-Tropsch unit, is then pumped from the heater unit to a HTL reactor via an HP pump, and then back to the heater unit;
From the heater unit following the HTL reactor, the feed is moved to a cooler and then to a product separator;
The product separator outputs non-condensable gases and biocrude oil (which is then pumped to the supercritical water gasification unit of FIG. 9B); and
The product separator also outputs to an HTL water collection that outputs a salt purge, and water recycled after salt separation that goes to the high pressure feed pump.

FIG. 9B depicts an example of a supercritical water (SCVV) biocrude gasification unit that involves:
Receiving the biocrude oil from the HTL unit of FIG. 9A, which is moved to a heat recovery unit, and then a heater;
From the heater, the feed is moved to a SCWG reactor (which has an output to energy sink ‘E’);
Feed output from the reactor is moved back to the heat recovery unit, and then to a pressure reducing turbine (which also outputs to energy sink ‘E’);
From the turbine, the feed is moved to another heat recovery unit, then to a cooler;
From the cooler, the feed is moved to an high-pressure gas/liquid separator (an HP flash) that outputs an aqueous phase and a biogas (which is then moved to the reforming unit of FIG. 9C); and
The aqueous phase is made part of a water recycle, that accepts make-up water and then is fed back to the second heat recovery unit (which feeds heat to the heater).

FIG. 9C depicts an example of a reforming unit that involves:
Receiving the biogas from the SCWG unit of FIG. 9B, which is moved to a heat recovery unit, and then to an HRSG;
   A heat recovery steam generator (HRSG) inputs also include make-up water (pumped to the HRSG via an HRSG feed water pump);
   An HRSG output includes a surplus stream to energy sink ‘E’;
   The heat recovery unit and HRSG both also feed a steam methane/dry methane reformation unit (SMR/DMR), an output of which is fed back to the heat recovery unit;
From the HRSG, the feed is moved to a cooler, and then to an HP flash;
Another HP flash input includes recycle water from make-up water; and
From the HP flash, the feed is moved to a CO₂ clean-up unit that outputs syngas that may be directed to a Fischer-Tropsch unit, and CO₂ (including recycle CO₂ that is fed back to the heat recovery unit, and surplus CO₂).

Step 3 of FIG. 1 is directed towards conversion of synthesis gas to a mixture comprising liquid hydrocarbons via a Fischer-Tropsch synthesis (see unit 3.1 in FIG. 1). Methanol synthesis is an alternative process that can be employed for this step, but conversion of methanol to hydrocarbons is known to produce 1,2,4,5-tetramethylbenzene, a highly undesirable kerosene range product when producing jet fuel.

In its simplest form, the main reactions during step 3 for Fischer-Tropsch synthesis can be represented by the following Equations 1-6, where Equation 6 is relevant only in iron-catalyzed Fischer-Tropsch synthesis:

Alkenes: nCO+2nH₂→(CH₂)ₙ+nH₂O (1)

Alkanes: nCO+(2n+1)H₂→H(CH₂)ₙH+nH₂O (2)

Alcohols: nCO+2nH₂→H(CH₂)ₙOH+(n−1)H₂O (3)

Carbonyls: nCO+(2n−1)H₂→(CH₂)ₙO+(n−1)H₂O (4)

Carboxylic acids: nCO+(2n−2)H₂→(CH₂)ₙO₂+(n−2)H₂O (5)

Water gas shift: CO+H₂O [symbol] CO₂+H₂ (6)

The value of n in Equations 1 to 6 depends on the probability of chain growth. The probability of chain growth, or alpha-value, depends on the nature and operation of the Fischer-Tropsch catalyst. The product distribution is reasonably well represented by an Anderson-Schulz-Flory distribution. With the Fischer-Tropsch synthesis of the herein described process, products from the Fischer-Tropsch synthesis will typically have carbon numbers in the range of n=1 to 100, although some products with n>100 may form.

In an example of step 3, iron-catalyzed Fischer-Tropsch synthesis is employed for conversion of synthesis gas to product mixture comprising liquid hydrocarbons. Iron-catalyzed Fischer-Tropsch syntheses does not require the synthesis gas composition to be adjusted to meet the hydrogen-to-carbon monoxide usage ratio of approximately 2 to 1, because iron-based Fischer-Tropsch catalysts are capable of performing the water-gas shift reaction. In an example, iron-catalyzed Fischer-Tropsch synthesis is performed at a temperature of 240° C. and higher, or at a temperature in a range 240 to 280° C. Operating the Fischer-Tropsch synthesis at a higher temperature allows the exothermic heat of reaction to be removed by high-pressure steam production, typically to generate steam at a pressure of 4 M Pa or higher.

In another example of step 3, the iron-based Fischer-Tropsch synthesis is performed with a synthesis gas that has a hydrogen-to-carbon monoxide ratio less than 2 to 1. In another example, the iron-based Fischer-Tropsch synthesis is performed with a synthesis gas that has a stoichiometric ratio, (H₂—CO₂)/(CO+CO₂), of less than 2 to 1. In another example, the iron-based Fischer-Tropsch synthesis is performed with a synthesis gas that has a Ribblet ratio, (H₂)/(2 CO+3 CO₂), of less than 1 to 1. In another example, the design of the Fischer-Tropsch synthesis is such that the mixture comprising liquid hydrocarbons from the Fischer-Tropsch synthesis has an alkene to alkane ratio that is greater than 1 to 1. Said alkene to alkane ratio being greater than 1 to 1 is generally desired for the process as described herein given that, as the alkene:alkane ratio decreases, oligomerization can be affected (e.g. the oligomerization yield can be decreased), which can reduce the ability to produce fully synthetic jet.

In another example, the design of the Fischer-Tropsch synthesis is such that the once-through carbon monoxide conversion of synthesis gas during Fischer-Tropsch synthesis is high, typically higher than 80% and more preferably higher than 90%. In another example, the design of the Fischer-Tropsch synthesis is such that steam is fed to the Fischer-Tropsch synthesis as necessary for the reaction to proceed without excessive carbon formation.

Following is a more detailed description of an example of step 3 of FIG. 1 (see FIG. 2). In step 3, the synthesis gas that is represented by stream 299 in FIG. 2, is converted by Fischer-Tropsch synthesis represented by block 300, into a mixture comprising liquid hydrocarbons represented by streams 301 and 302. Step 3 is conducted at temperature and pressure conditions where it is likely that the Fischer-Tropsch reactor will have a gas phase and a liquid phase present with the catalyst in the solid phase. The reaction products from the Fischer-Tropsch synthesis (i.e., a mixture comprising liquid hydrocarbons) could leave the reactor as two separate phases, with the reactor itself serving as both reactor and phase separator. In FIG. 2, stream 301 is the gas phase product and stream 302 is the liquid phase product leaving the Fischer-Tropsch reactor, block 300. The exact nature and position of the gas phase product and liquid phase product exiting the reactor depends on the specific reactor technology that is selected, such as a multitubular fixed bed reactor, or a slurry phase bubble column reactor. Any device needed to retain the catalyst in block 300, is considered part of the technology in that block. Depending on the operation of the Fischer-Tropsch synthesis, the relative amount of products in streams 301 and 302 could vary. In an example, no material leaves block 300 as stream 302. Due to the exothermic nature of the reaction in block 300 in FIG. 2, water is supplied as stream 303 and vaporized to produce steam as stream 304. The water supplied in stream 303 does not mix with the process and both streams 303 and 304 can be considered utility streams separate from the process, but that are integral to heat removal from block 300.

Step 4 of FIG. 1 is directed towards separating the product from Fischer-Tropsch synthesis (i.e., the mixture comprising liquid hydrocarbons) by separating the mixture into at least four product fractions (see unit 4.1 in FIG. 1): (4a) aqueous product, (4b) a naphtha and gas product, (4c) a kerosene product, and (4d) a gas oil and heavier product. The aqueous product comprises water and water-soluble molecules that are condensed during product separation. The naphtha and gas product comprises all of the material not present in the aqueous product that has a normal boiling point temperature that is lower than that of kerosene. The kerosene product comprises hydrocarbons with a boiling range that is compatible with distillation requirements for jet fuel; broadly speaking, the kerosene product has a normal boiling point temperature range of 140 to 300° C. The gas oil and heavier product comprises material with a normal boiling point temperature higher than that of kerosene. In some examples, the four products are not isolated as precise cuts. In some examples, vapor-liquid equilibria would naturally result in some separation in the reactor for Fischer-Tropsch synthesis. Part or all of the gas oil and heavier product (see stream 4d in FIG. 1) could be available as a separate liquid product from Fischer-Tropsch synthesis see (unit 3.1 in FIG. 1) and not require separation in the fourth step. To separate the heavier and lighter products of the Fischer-Tropsch synthesis for conveniently upgrading to jet fuel, a combination of vapor-liquid equilibrium separation techniques at different pressure and temperatures is used, and may be combined with distillation of selected separated fractions. This avoids necessity of an atmospheric distillation unit in this part of the process, which can make step 4 relatively more energy efficient and less capital intensive.

Following is a more detailed description of an example of step 4 of FIG. 1 (see FIG. 2). The temperature of the gas phase product in stream 301 in FIG. 2 is decreased in block 400. It is possible to effect this change in temperature by devices known in the art. In an example, the temperature of stream 301 is decreased by heat exchange with stream 299 in a feed-product heat exchanger represented by block 400. The temperature change in block 400 can also be effected in other ways, such as with a utility stream, or by cooling with air. In another example, the temperature of stream 401 is such that the water present in stream 301 condensed and that the water in stream 401 is at its bubble point, or below its bubble point. The relationship between the bubble point temperature of the water in stream 401 and the pressure is determined by vapor-liquid equilibrium. In another example, the temperature of 401 is controlled and held constant by means of process control. Furthermore, this temperature is selected by optimizing product routing to step 5, instead of being used to condense more material, as is generally industrial practice. Therefore, this temperature is controlled to be at, or near the bubble point of water in stream 401. Stream 401 enters a phase separator, represented by block 410 in FIG. 2. In this example, the phase separator is a three-phase phase separator. The purpose of the phase separator is to enable separation of the phases present in stream 401 to produce a gas phase stream 411, organic liquid phase stream 412 and an aqueous liquid phase stream 413. In one example, block 400 and 410 are combined in one device that enables both temperature change and phase separation in the same device. In another example, block 400 and 410 are combined in such a way that the device has more than one equilibrium stage to effect separation into streams 411, 412, and 413.

The relationship between the streams shown in FIGS. 1 and 2 are indicated on FIG. 2. The gas phase stream 411 comprises mainly gaseous and naphtha fraction products, stream (4b). The organic liquid phase stream 412, comprises mainly the kerosene product, stream (4c). The aqueous product stream 413, comprises mainly water with dissolved organic compounds that are mainly oxygen-containing compounds, stream (4a). The liquid product from the Fischer-Tropsch reactor is stream 302 and comprises of mainly gas oil and heavier organic compounds, stream (4d). The design and control of the herein described separation enables product routing in such a way that it is not necessary to make use of a separate atmospheric distillation unit prior to any of the units in step 5. This exploits the energy already available in the hot products from unit 300, without undermining refinery operation.

Step 5 of FIG. 1 is directed towards refining the four product fractions separated from the Fischer-Tropsch liquefaction product (i.e., the mixture comprising liquid hydrocarbons). Refining employs three processes, namely, oligomerization (see unit 5.1 in FIG. 1), hydrocracking (see unit 5.2 in FIG. 1), and hydrotreating (see unit 5.3 in FIG. 1). The aqueous product (see 4a in FIG. 1) is recycled to be a feed in synthesis gas production (see unit 2.2 in FIG. 1). The aqueous product, like the hydrothermal liquefaction product, is acidic in nature. The combination of hydrothermal liquefaction product and Fischer-Tropsch aqueous product exploits the common need for acid resistant construction material. Co-feeding the aqueous product with the hydrothermal liquefaction product (i.e., the mixture comprising biocrude) enables substantial conversion of the acids to synthesis gas, instead of relying on chemical dosing. It eliminates treating the aqueous product separately as an acidic wastewater with a high chemical oxygen demand, a costly necessity often encountered in industrial Fischer-Tropsch based coal-to-liquid and gas-to-liquid facilities.

The straight run gas and naphtha product (4b in FIG. 1) is not further separated, as is common practice in separation after Fischer-Tropsch synthesis. The gas and naphtha product, which also contains unreacted synthesis gas, is directly used as a feed material for an oligomerization process. The oligomerization process refers to a conversion process that involves an addition reaction of two or more unsaturated molecules. Such an approach facilitates conversion of lighter olefinic (i.e., alkenyl) products to heavier olefinic products, which are easier to recover by condensation. Further, the more dilute nature of the feed assists with heat management in the exothermic oligomerization process, and the presence of hydrogen in the gas can suppress coking reactions. Further, oxygen-containing organic molecules (oxygenates) are converted to hydrocarbons, even though this conversion may not be complete. In an example, the oligomerization process employs a non-sulfided catalyst, such as an acidic ZSM-5 zeolite (MFI framework type) as catalyst.

In its simplest form, the main reactions during operation of the oligomerization process can be represented by the following Equations 7-9:

Oligomerization/cracking: CₓH₂ₓ+C_{y}H_{2y} [symbol] C_{(x+y)}H_{(2x+2y)} (7)

Aromatization: alkenes→aromatics+alkanes (8)

Aromatic alkylation/dealkylation: (C₆H₅)CₓH₍₂ₓ₊₁₎+C_{y}H_{2y} [symbol] (C₆H₅)C_{(x+y)}H_{(2x+2y+1)} (9)

In addition to the reactions in Equations 7-9, there are various reactions involving oxygen-containing compounds, such as dehydration and ketonization, which may take place. The reactions described are not intended to be exhaustive, but are provided for illustrative purposes. The relative prevalence of these reactions depends on the temperature and pressure conditions of the oligomerization process. Through manipulation of the operating conditions in the oligomerization process, it is possible to produce a kerosene material that enables the blending of fully synthetic jet fuel from the process described herein. By operating at least part of the oligomerization catalyst at a temperature and pressure that favors aromatization (Equation 8), the total amount of aromatics can be manipulated to increase or decrease the amount of fully synthetic jet fuel in relation to semi-synthetic jet fuel produced by the process described herein. In one example, a non-sulfided catalyst, such as an unpromoted ZSM-5 catalyst is used.

In an example of the oligomerization process as described herein, operating temperatures in a range or about 200° C. to about 320° C. would generally produce a product useful as a blend material for production of semi-synthetic jet fuel, because it would be an isoparaffinic kerosene after hydrotreatment (e.g., see Examples 1 and 4). Operating temperatures of about >320° C. (nominally about 320° C. to about 400° C.) would typically be used to produce a product with more aromatics, which would be suitable for blending fully synthetic jet fuel after hydrotreating to saturate the olefins (e.g., see Examples 2 and 5). In some examples, in both cases, pressure can be varied over a wide range, e.g. about 0.1 MPa to about 20 MPa.

Generally, the process as described herein can be operated at a pressure commensurate to, or slightly lower than the Fischer-Tropsch synthesis as described herein, e.g. around 2 MPa, despite operation at higher pressure generally being easier due to the higher partial pressure of olefins. Operating at a pressure commensurate to, or lower than the Fischer-Tropsch synthesis as described herein, without requiring prior separation to remove unconverted synthesis gas, avoids separation and recompression in the process as described herein.

In another example, the oligomerization process uses the gaseous product stream 411 (FIG. 2), which includes the unconverted synthesis gas from the Fischer-Tropsch process. Unconverted synthesis gas includes, but is not limited to H₂, CO, CO₂, and H₂O. It is common practice to separate the light olefins from the unconverted synthesis gas, which comprises H₂, CO, and CO₂, eliminating a separation step that is usually present. Also, by employing oligomerization, alkenes, including ethylene, are converted to heavier products that are more easily recovered after oligomerization than before oligomerization.

The product from the oligomerization process (e.g., a mixture comprising a first additional kerosene product) comprises unconverted material and new products. The unconverted material comprises hydrogen, carbon monoxide and paraffinic hydrocarbons. The new products have a boiling range distribution spanning gas, naphtha and distillates, material ranging from normally gaseous compounds to compounds with a normal boiling point temperature up to 360° C. The new products include a first additional kerosene product. The first additional kerosene product comprises olefinic and aromatic compounds. The ratio of olefinic to aromatic compounds depends on the operating conditions of the oligomerization process. This flexibility in adjusting the ratio of olefinic to aromatic compounds facilitates production of semi-synthetic jet fuel and production of fully synthetic jet fuel. The additional kerosene product (see 5a in FIG. 1) is sent to the hydrotreater (unit 5.3 in FIG. 1). The liquid product outside of the kerosene range (see 5b in FIG. 1) can be handled in one or more combinations of the following: (i) recovered as final products (as shown in FIG. 1), (ii) sent to the hydrotreater (not shown in FIG. 1), (iii) recycled to the oligomerization process (not shown in FIG. 1), and/or recycled to synthesis gas production (see unit 2.2 in FIG. 1).

In one example, the olefinic and aromatic compounds outside the boiling range of kerosene are recovered as products. In another example, some or all of the olefinic and aromatic compounds outside the boiling range of kerosene are recycled to the oligomerization process. In another example, some or all of the olefinic and aromatic products outside the boiling range of kerosene are sent to the hydrotreater.

The unconverted material from the oligomerization process may at least be employed as source of hydrogen for the hydrocracker and hydrotreater. The nature of gas treatment downstream of the oligomerization involves processes known to those skilled in the art of gas treating, such as hot carbonate absorption to remove carbon dioxide, and pressure swing adsorption to recover hydrogen.

The kerosene product (see 4c in FIG. 1) is sent to the hydrotreater. Optionally part or all of this product may also be sent to a hydrocracker unit (routing not shown in FIG. 1). The factor that determines whether any of this product is sent to the hydrocracker is the freezing point specification of the target jet fuel. For example, straight run Fischer-Tropsch kerosene typically has a high linear hydrocarbon content. If there is too high concentration of linear hydrocarbons in kerosene, however, the temperature of onset of freezing will be too high to meet aviation turbine fuel specifications.

Following is a more detailed description of an example of the oligomerization unit in step 5 of FIG. 1. The oligomerization unit in step 5 is depicted in more detail in FIG. 3. The conversion of stream 411 (i.e., the naphtha and gas product), which comprises of hydrocarbons, oxygen-containing organic compounds and unconverted synthesis gas, takes place in the oligomerization unit 510. The product from 510 is stream 511 (i.e., the mixture comprising a first additional kerosene product), which comprises of a mixture of hydrocarbons that are on average heavier than those in stream 411, substantially less oxygen-containing organic compounds and unconverted synthesis gas. The composition of the hydrocarbons in 511 depends on the operating conditions in 510, as described before.

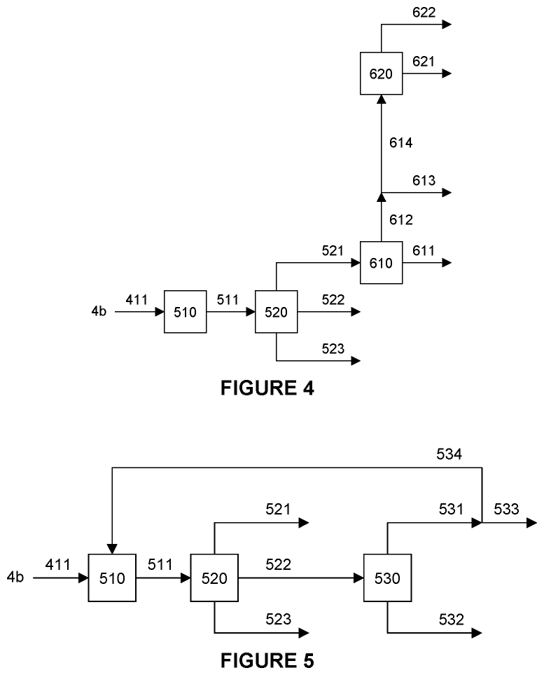

Stream 511 is separated in 520. In one example, stream 511 is separated to produce a gaseous product 521, an organic liquid product 522, and a water-rich liquid product 523. This type of separation may be achieved by decreasing the temperature to condense part of 511, which can then be separated in a three-phase vapor-liquid-liquid separator. Another way to achieve this type of separation is to employ a device with more than one equilibrium stage. Another way to achieve this type of separation is to use a device that employs liquid absorption. Stream 521 can be applied in various ways. One potential use of stream 521 is as fuel gas. Another potential use of stream 521 is to recycle part or all of 521 to either the Fischer-Tropsch synthesis or the synthesis gas production. In an example, stream 521 is treated as shown in FIG. 4. Stream 521 is treated in unit 610 to remove part or nearly all of the carbon dioxide to produce a CO₂-rich stream 611 and a CO₂-depleted stream 612. This type of separation may be performed by process technology known in the art, such as hot carbonate absorption, or amine absorption. The CO₂-rich stream 611 is an effluent, but on account of its high CO₂ concentration, stream 611 may be suitable as feed for CO₂ sequestration or direct discharge. The CO₂-depleted stream 612 can be divided with part or all of stream 612 going to stream 613. The remainder of stream 612 that does not go to stream 613 can go to stream 614. Due to the decreased CO₂ content in stream 613, it may be employed for the same purposes as 521, but with improved efficiency over the direct use of 521.

Stream 614 is further separated in unit 620. Unit 620 is employed to recover part of the hydrogen present in 614 as stream 621, the remainder of the material being in stream 622. One of the technologies commonly employed for the separation in 620 is pressure swing adsorption, which would produce H₂ in stream 621 as a high purity hydrogen stream. The hydrogen in stream 621 would be employed for use in units 5.2 and 5.3 shown in FIG. 1. Stream 522 is sent to the hydrotreater, unit 5.3 in FIG. 1.

Optionally, the organic liquid product 522 can be further separated. This option is depicted in FIG. 5, which shows the separation of 522 in unit 530 into a lighter fraction represented by stream 531, and a heavier fraction represented by stream 532. The lighter fraction in 531 is typically material with a normal boiling point of less than 140° C., and the heavier fraction in 532 is typically material with a normal boiling point of 140° C. and higher. Stream 532 is sent to the hydrotreater, unit 5.3 in FIG. 1. The lighter fraction, stream 531, can be divided with part or all of stream 531 going to stream 533. The remainder of stream 531 that does not go to stream 533 can go to stream 534. Stream 534 is recycled to the oligomerization unit 510 to convert part of the lighter fraction to products that will after conversion form part of the heavier fraction that is represented by 532. Thus, the recycling of stream 534 enables conversion of part of the light fraction into a heavy fraction, thereby increasing the ratio of 532 compared to 531, which increases the amount of material that will be suitable for jet fuel production. Stream 533 is typically naphtha with acceptable properties for blending into motor-gasoline and can be sold as such. Stream 523 is combined with stream 413 and used as stream 4a in FIG. 1. Optionally, stream 523 is considered a wastewater stream and treated as a wastewater stream.

The gas oil and heavier product (see 4d in FIG. 1) is sent to the hydrocracker, which converts the gas oil and heavier product to lighter boiling products (i.e., a mixture comprising a second additional kerosene product). The molecules in the product are also more branched than the molecules in the gas oil and heavier product. The second additional kerosene product from the hydrocracker can be used directly for blending to aviation turbine fuel. The remainder of the product can also be used as final products. Optionally, the lighter products can be used as a co-feed to the oligomerization unit. In an example, part or all of the material in the product with a higher boiling point than kerosene is recycled. In another example, a non-sulfided catalyst, such as a reduced noble metal supported on amorphous silica-alumina catalyst is used to perform hydrocracking in a fixed bed reactor. An example of a reduced noble metal supported on amorphous silica-alumina catalyst is Pt/SiO₂—Al₂O₃. Such catalysts would have a high metal-to-acid activity ratio to promote hydroisomerization.

In another example of the process as described herein, the hydrocracker is operated at a lower pressure than the Fischer-Tropsch synthesis to enable direct use of hydrogen recovered from the unconverted product after the oligomerization process (e.g., see Example 3). Generally, hydrocracking is performed at about 350° C. to about 400° C., and at pressures of >3 MPa (e.g., typical mild hydrocracking at pressures of about 5-8 MPa and typical severity hydrocracking at pressures of about 10-20 MPa). However, as is demonstrated in Example 3 (see below), hydrocracking as described herein was performed using a pressure of <3 MPa (e.g., about 2 MPa), at a temperature of about 320° C. In some examples, hydrocracking as described herein can be performed at a temperature of about 320° C. to about 400° C., or about 320° C. to about 380° C., or about 320° C. to about 350° C. In other examples, hydrocracking as described herein can be performed at a pressure of about 1 MPa to about 20 MPa, or about 1 MPa to about 15 MPa, or about 1 MPa to about 10 MPa, about 1 MPa to about 5 MPa, or about 1 MPa to about 3 MPa, or about 1 MPa to about 2 MPa.

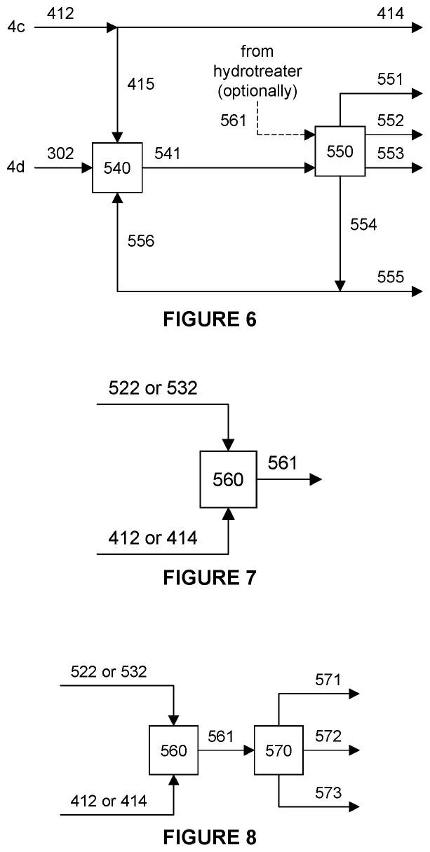

Following is a more detailed description of an example of the hydrocracking unit in step 5 of FIG. 1. The hydrocracking unit in step 5 is depicted in more detail in FIG. 6. The primary feed (e.g., the gas oil and heavier product) to the hydrocracker unit 540 is stream 302. Optionally, the organic liquid stream 412 can be divided with part or all of stream 412 going to stream 414. The remainder of stream 412 that does not go to stream 414 can go to stream 415. Stream 415 is also a feed to the hydrocracker unit 540. Feeding stream 415 to the hydrocracker is typically required only if the onset of freezing point in the synthetic jet fuel is higher than the specification limit of −47° C. In the hydrocracker unit 540, the feed materials are hydrocracked and hydroisomerized. In an example, stream 415 is not exposed to all of the catalyst in the hydrocracker, but introduced partway as an inter-bed feed. By doing so stream 415, which is a lighter boiling feed than stream 302, is less likely to be hydrocracked and more likely to be hydroisomerized. By doing so, the yield of synthetic jet fuel is improved over conventional operation with a single liquid feed point to the hydrocracker. The product from hydrocracking and hydroisomerization in 540 is stream 541.

The hydrogen feed and hydrogen recycled system of the hydrocracker unit 540 is not explicitly shown. The hydrogen loop of hydrocracking technology is known in the art (for example, Scherzer, J.; Gruia, A. J. Hydrocracking science and technology; CRC Press: Boca Raton, Fla., 1996). The hydrogen feed for the hydrocracker can be obtained from stream 621 in FIG. 4, or in other ways described in the art, such as separation from the synthesis gas produced in step 2 of this invention.

Product stream 541 is separated in different fractions in separator unit 550. Optionally, the product from the hydrotreater, unit 5.3 in FIG. 1 could be separated with stream 541 to reduce the number of separation steps. In separator unit 550, which is typically performed by distillation, the material is separated in a light hydrocarbon stream 551, a kerosene range hydrocarbon stream 552 that is suitable for synthetic jet fuel blending, a gas oil stream 553 and an atmospheric residue stream 554. It is possible to select the separation in such a way that stream 553 is zero. The separation in unit 550 is performed primarily to ensure that stream 552 is suitable for synthetic jet fuel. Optionally, the heaviest product, stream 554 can be divided with part or all of stream 554 going to stream 555. The remainder of stream 554 that does not go to stream 555 can go to stream 556. Stream 556 is recycled to the hydrocracker unit 540. In an example, stream 556 is not exposed to all of the catalyst in the hydrocracker, but introduced partway as an inter-bed feed.

Stream 551 can be further separated into product fractions and sold as propane, butanes, and naphtha. This material may also be used for subsurface recovery of bitumen from oil sands deposits. The naphtha may be used as blend material for motor-gasoline, or as refinery feed or petrochemical feed. The naphtha may be employed as diluent for oil sands derived bitumen, or in processes such as paraffinic froth treatment for bitumen recovery. Stream 552 is used for semi-synthetic jet fuel. Stream 553 may be sold as a diesel fuel blend component and will typically have a cetane number of equal or better than 51, contain no sulfur, and have acceptable cold flow properties. Stream 554 can be sold as lubricant base oil blend component, zero sulfur fuel oil, or synthetic oil.

The feed materials (e.g., the kerosene products) that are sent to the hydrotreater are hydrogenated to substantially convert olefinic and oxygen-containing molecules to paraffinic molecules. The product after hydrotreating is fractionated to obtain final products. The kerosene fraction is fractionated to be suitable as aviation turbine fuel.

In an example, a non-sulfided, reduced base metal supported on alumina, or silica catalyst is used to perform hydrotreating in a fixed bed reactor. An example of a reduced base metal supported on alumina catalyst is a reduced Ni/Al₂O₃ catalyst. Making use of a reduced metal (e.g., hydrotreating) catalyst instead of a sulfided base metal (e.g, hydrotreating) catalyst allows addition of sulfur to the feed to be avoided, and allows reactions such as the hydrotreating to be performed at milder conditions than with a sulfided base metal (e.g., hydrotreating) catalyst. In some examples, the hydrotreater is operated at a temperature of about 80° C. to about 200° C., or about 80° C. to about 180° C., or about 80° C. to about 150° C. In other examples, the hydrotreater is operated at a temperature of about 180° C. to about 420° C., or about 180° C. to about 380° C., or about 260° C. to about 380° C. In an example, the hydrotreater is operated at a lower pressure than the Fischer-Tropsch synthesis to enable direct use of hydrogen recovered from the unconverted product after the oligomerization process. In other examples, the hydrotreater is operated at a pressure of about 0.5 MPa to about 20 MPa, or about 1 MPa to about 15 MPa, or about 1 MPa to about 10 MPa, about 1 MPa to about 5 MPa, or about 1 MPa to about 3 MPa, or about 1 MPa to about 2 MPa. In another example of hydrotreating as described herein, it was found that, using a model feed (10% 1-hexene, 5% toluene, 85% n-octane), near complete conversion of olefins was possible at about 80° C. and about 1 MPa with reduced Ni/Al₂O₃.

A major product from the herein described process is a kerosene range material that meets the specification requirements for synthetic aviation turbine fuel, either as a semi-synthetic jet fuel blend component or a fully synthetic jet fuel.

Following is a more detailed description of an example of the hydrotreating unit in step 5. The hydrotreating unit in step 5 is depicted in more detail in FIG. 7. The hydrotreater receives two organic feed materials, one from the oligomerization unit (i.e., the first additional kerosene product) and one from separation after the Fischer-Tropsch synthesis (i.e., the kerosene product). The material from the oligomerization unit is either stream 522, or stream 532, depending on whether stream 522 was further separated or not. The material from separation after the Fischer-Tropsch synthesis is either stream 412, or stream 414, depending on whether any or all of this material was sent to the hydrocracking unit in stream 415. It is therefore possible for the hydrotreater to receive only feed from the oligomerization unit. The hydrogen feed and hydrogen recycled system of the hydrotreater unit 560 is not explicitly shown. The hydrogen feed for the hydrotreater can be obtained from stream 621 in FIG. 4, or in other ways known in the art, such as separation from the synthesis gas produced in step 2 of this invention.

The product from hydrotreating is stream 561. The product in stream 561 is substantially free from alkenes and oxygen-containing organic compounds. The product in stream 561 consists of mainly alkanes, cycloalkanes, and aromatics, the relative abundance of each compound class depends on both the operation of the hydrotreater unit 560, and the composition of the feed materials to the hydrotreater. When the feed material to the hydrotreater unit 560 comprises only of stream 532, it is likely that all of stream 561 is suitable for use as either fully synthetic jet fuel, or semi-synthetic jet fuel. Stream 561 is suitable as fully synthetic jet fuel when the aromatic content of stream 561 is between 8 and 25 vol %, and the distillation range of stream 532 is appropriately selected in accordance with jet fuel specifications. The here described process provides a refining process to produce a fully synthetic jet fuel from a Fischer-Tropsch product (i.e., the mixture comprising liquid hydrocarbons) that employs only two conversion steps, the oligomerization unit 510 and the hydrotreater unit 560.

Stream 561 is suitable as a semi-synthetic jet fuel when the aromatic content is lower, and the distillation range of stream 532 is appropriately selected in accordance with jet fuel specifications. The herein described process provides a refining process to produce a semi-synthetic jet fuel from a Fischer-Tropsch product (i.e., the mixture comprising liquid hydrocarbons) that employs only two conversion steps, the oligomerization unit 510 and the hydrotreater unit 560.

Optionally, and irrespective of the composition of the feed materials going to the hydrotreater unit 560, stream 561 may be separated in unit 550 as shown in FIG. 6. Optionally, and irrespective of the composition of the feed materials going to the hydrotreater unit 560, stream 561 can be further separated in unit 570 as shown in FIG. 8. Separation of stream 561 in unit 570 is convenient to produce products based on their distillation range that are useful for different applications. Separation of stream 561 in unit 570 produces a naphtha stream 571, a kerosene stream 572, and a gas oil stream 573. Stream 571 is a naphtha range product. The naphtha may be used as blend material for motor-gasoline, or as refinery feed or petrochemical feed. The naphtha may be employed as diluent for oil sands derived bitumen, or in processes such as paraffinic froth treatment for bitumen recovery. Stream 572 is used for semi-synthetic jet fuel or used for fully synthetic jet fuel. Stream 573 can be sold as a diesel fuel blend component and will typically have a cetane number of equal or better than 51, contain no sulfur, and have acceptable cold flow properties.

In some examples, it is possible to operate the oligomerization process in such a way that little or no aromatics are produced. This type of operation is useful for increasing semi-synthetic jet fuel production (and extending catalyst cycle life time). In a specific example, the aromatic content is 8% or more, for example up to about 60%, the stream may be useful for fully synthetic jet fuel production, either on its own, or as a blend with one of the other kerosene streams that do not contain aromatics. Preferably, the fully synthetic jet fuel will have between 8 and 25% aromatics. In some examples, the aromatic content is less than 8%. In other examples, the aromatic content is about 0 to 1%. In this example, the stream may be useful as blend component for semi-synthetic jet fuel, with some of the pre-approved synthetic jet fuel classes (isoparaffinic kerosenes) having <1% aromatics.

In examples of the process as described herein, the overall process generates a sufficient amount of H₂ to conduct each process step that requires H₂ as a reactant/input (e.g., as depicted in any one of FIGS. 1 to 8) without having to use H₂ from sources external to the process (e.g., a methane reformer/methane reformation, etc.). In examples, the process as described herein does not require an input of H₂ from external sources.

In other examples of the process as described herein, the final output of the process—jet fuel having a high boiling point (e.g., between 140° to 260°) and a low freezing point (e.g., <−60° C.)—is produced in high yield. In some examples, the process as described herein produces more jet fuel having a high boiling point (e.g., between 140° to 260°) and a low freezing point (e.g., <−60° C.) than other, incumbent or standard technologies.

In other examples of the process as described herein, use of a gas compressor(s) between the Fischer-Tropsch unit (e.g., unit 3.1 in FIG. 1) and the refining units (oligomerization (e.g., unit 5.1 in FIG. 1), hydrocracking (e.g., unit 5.2 in FIG. 1), and hydrotreating (e.g. unit 5.3 in FIG. 1)) is not required to increase the pressure at which the refining units operate. In some examples, the process as described herein uses the pressure from the Fischer-Tropsch unit (e.g., unit 3.1 in FIG. 1) to conduct the processes of the refining units (oligomerization (e.g., unit 5.1 in FIG. 1), hydrocracking (e.g., unit 5.2 in FIG. 1), and hydrotreating (e.g. unit 5.3 in FIG. 1)). In some examples, the final refining steps as described herein (oligomerization (e.g., unit 5.1 in FIG. 1), hydrocracking (e.g., unit 5.2 in FIG. 1), and hydrotreating (e.g. unit 5.3 in FIG. 1)) are conducted at a pressure commensurate to that of the Fischer-Tropsch synthesis as described herein: for example, at a pressure of approximately 2 MPa; or approximately 2.5 MPa; or in a range of about 1.5 MPa to 3 MPa; or in a range of about 1.5 MPa to about 2.5 MPa; or in a range of about 2 MPa to about 2.5 MPa. This is in contrast with, for example, standard hydrotreating conditions, which require minimum pressures of about 8 to 10 MPa.

Following is a more detailed description of other examples of the final refining steps of the process as described herein; particularly oligomerization (e.g., unit 5.1 in FIG. 1), hydrocracking (e.g., unit 5.2 in FIG. 1), and hydrotreating (e.g. unit 5.3 in FIG. 1).

Example 1—Semi Synthetic Jet Fuel, 50% Blend. A fixed bed continuous flow reactor was employed to produce an olefinic kerosene range product in accordance with, for example, oligomerization unit 5.1 in FIG. 1. Using a commercially obtained, non-sulfided H-ZSM-5 catalyst, a mixture of light paraffins, olefins and oxygenates in the carbon number range C₁-C₈ was converted over the catalyst at 240-280° C. and 2 MPa to a produce a product that included kerosene range material. The carbon number range of the feed was wider than described by the state of the art. The pressure was lower than typically used for oligomerization, and was typical of the outlet pressure after Fischer-Tropsch synthesis (e.g., steps 3 and 4 in FIG. 1). The feed material represents, for example, stream 4b in FIG. 1 and stream 411 going to unit 510 in FIG. 3. The olefin concentration in feed was 24 wt %.

In this example the reactor was operated on a once-through basis. The conversion of light olefins, using propylene as example, was >95%. The mass selectivity to >140° C. material, which could potentially be suitable to inclusion in a jet fuel blend, was 29%. As was previously described (Garwood, W. E. ACS Symp. Ser. 1983, 218, 383-396), the carbon number distribution over H-ZSM-5 is determined by the combination of temperature and pressure. An engineering approach that may be employed to increase overall yield of the >140° C. fraction, is to have an internal recycle of naphtha (C₅−140° C.) to an oligomerization reactor. This was not done in the present example, as it was already known.

Olefinic product from the oligomerization was hydrotreated over a reduced, non-sulfided Ni/Al₂O₃ catalyst to an olefin content of <1%. For example, the hydrotreater is unit 5.3 in FIG. 1. The hydrotreated product was distilled into different boiling fractions, and each boiling fraction was characterized in terms of density and onset of freezing point (see Table 1). The number of fractions prepared were to illustrate the suitability of different cuts for potential inclusion in a jet fuel blend, and is not intended to represent a suggested separation strategy.

TABLE 1
Characterization of the different distillation cuts
from the hydrotreated product from the oligomerization
conversion performed at 240-280° C. and 2 MPa.

| Boiling range | Density at 15.6° C. | Onset of freezing |
|---|---|---|
| (° C.) | (kg/m³) | (° C.) |
| 140-150 | 730 | <−60 |
| 150-160 | 740 | <−60 |
| 160-170 | 747 | <−60 |
| 170-180 | 753 | <−60 |
| 180-240 | 770 | <−60 |
| 240-250 | 786 | <−60 |
| 250-260 | 791 | <−60 |
| >260 | 812 | not determined |

It is noteworthy that all of the distillation cuts in the 140-260° C. boiling range met the maximum onset of freezing point specification of Jet A-1, which is −47° C. It is typically difficult to obtain (e.g., using incumbent or standard technologies) a product having a high boiling point (e.g., between 140° to 260°) and a low freezing point (e.g., <−60° C.). This supports that the process as described herein is capable of maximizing jet fuel yield.

Example 2—Full Synthetic Jet Fuel, 100% Blend. The process has the potential to produce material that will enable formulation of fully synthetic jet fuel, with no petroleum-derived material. One of the requirements for fully synthetic jet fuel is that it must contain 8-25 vol % aromatics. In this example, a fixed bed continuous flow reactor was employed to produce an olefinic and aromatic kerosene range product in accordance with, for example, oligomerization unit 5.1 in FIG. 1. The reactor, catalyst and feed material was similar to that in Example 1. The feed was a mixture of light paraffins, olefins and oxygenates in the carbon number range C₁-C₈ and it contained 25 wt % olefins. The feed was converted over the catalyst at 350-380° C. and 2 MPa to produce a product that included kerosene range material.

The olefinic and aromatic product from the oligomerization reactor was hydrotreated over a reduced, non-sulfided Ni/Al₂O₃ catalyst to an olefin content of <1%, but at conditions that would not substantially hydrogenate the aromatics to cycloparaffins. For example, the hydrotreater is unit 5.3 in FIG. 1. For the same reasons explained in Example 1, the hydrotreated product was distilled into different boiling fractions, and each boiling fraction was characterized in terms of density and onset of freezing point (Table 2).

TABLE 2
Characterization of the different distillation cuts
from the hydrotreated product from the oligomerization
conversion performed at 350-380° C. and 2 MPa.

| Boiling range | Density at 15.6° C. | Onset of freezing |
|---|---|---|
| (° C.) | (kg/m³) | (° C.) |
| 140-150 | 772 | <−60 |
| 150-160 | 791 | <−60 |
| 160-170 | 801 | <−60 |
| 170-180 | 809 | <−60 |
| 180-240 | 834 | <−60 |
| 240-250 | 863 | <−60 |
| 250-260 | 871 | <−60 |
| >260 | 881 | not determined |

All of the distillation cuts in the 140-260° C. boiling range met the maximum onset of freezing point specification of Jet A-1, which is −47° C. The higher density of the distillation cuts in Table 2 (compared with Table 1) was indicative of aromatics and cycloparaffins in the hydrotreated product. Typically, the aromatics content of synthetic jet fuel is from a fossil fuel source. In contrast, operating, e.g., unit 5.1 in FIG. 1 at higher temperatures enables the process to generate compound classes (i.e., aromatics) often absent from kerosene range blend materials for synthetic jet fuel blending. It also illustrates the flexibility of, e.g., unit 5.1 in FIG. 1 to be used in different operating modes.

Example 3. This example illustrates the performance of the hydrocracking unit, e.g., unit 5.2 in FIG. 1, when operated at a pressure similar to the Fischer-Tropsch synthesis, i.e. 2 MPa. A fixed bed continuous flow reactor was operated with a Pt/SiO₂-Al₂O₃ hydrocracking catalyst at 320° C., 2 MPa, Hz-to-feed ratio of 600 m³/m³ and liquid hourly space velocity of 2 h⁻¹. These conditions were selected to demonstrate operation at milder conditions than conventionally encountered for hydrocracking, and to illustrate the benefit thereof as applied in the process as described herein.

The feed material to the hydrocracker was wax, representative of, e.g., stream 4d in FIG. 1. When described in terms of boiling point, the wax was an atmospheric residue with an initial boiling point temperature of around 360° C., and it contained n-alkanes (paraffins) with carbon numbers C₂₄ and heavier. The reactor was operated on a once-through basis. For example, the engineering design to completely convert the wax by recycling the heavier product fraction to the hydrocracker is shown in FIG. 6. Of interest to manufacturing of synthetic jet fuel, is the selectivity ratio of kerosene to naphtha. At the operating conditions employed herein, the mass ratio of hydrocarbons in the 140-260° C. boiling range to hydrocarbons with boiling point <140° C., was 1:1.

Hydrocracked product separation did not reflect any separation strategy for the process, and narrow cuts were prepared for the same reason as described in Example 1. The density and onset of freezing point were determined for each of the narrow boiling fractions in the hydrocracked product (Table 3).

TABLE 3
Characterization of the different distillation cuts from the
hydrocracked product that was produced at 320° C. and 2 MPa.

| Boiling range | Density at 15.6° C. | Onset of freezing |
|---|---|---|
| (° C.) | (kg/m³) | (° C.) |
| 140-150 | 734 | <−60 |
| 150-160 | 740 | <−60 |
| 160-170 | 744 | <−60 |
| 170-180 | 750 | <−60 |
| 180-240 | 766 | <−60 |
| 240-250 | 778 | −49 |
| 250-260 | 780 | −45 |

The narrow distillation cuts in the 140-250° C. boiling range had an onset of freezing that met the maximum onset of freezing point specification of Jet A-1 of −47° C.

Example 4. A semi-synthetic jet fuel was blended using products described in Examples 1 and 3, together with a kerosene range product from a petroleum refinery. The kerosene range product from the petroleum refinery was re-distilled to remove the lighter than 150° C. boiling material. The remaining petroleum-derived kerosene was characterized, and had a density of 817.5 kg/m³, with an onset of freezing of −51° C.

A semi-synthetic jet fuel was prepared. The blend consisted of 25 vol % of the 160-260° C. fraction of the hydrotreated oligomerization product shown in Table 1, 25 vol % of the 160-240° C. fraction of the hydrocracked product shown in Table 3, and 50 vol % of the petroleum-derived kerosene. Considering the properties previously listed, a wider boiling range could have been used, but the purpose was to demonstrate that a viable semi-synthetic jet fuel could be produced by the process as described herein. The blend was not optimized to maximize the yield of jet fuel.

The semi-synthetic jet fuel prepared in this way was characterized and compared to Jet A-1 specification requirements (Table 4). A fuels laboratory performed the characterization, and added 1 mg/L Stadis 450 to the semi-synthetic jet fuel before characterization. This was the only commonly used additive as prescribed for jet fuel use that was added. The standard test methods and specifications listed in Table 4 were the methods and specifications as prescribed for the evaluation of Jet A-1 aviation turbine fuel.

In addition to those specifications listed in Table 4, cold flow density and viscosity of the semi-synthetic jet fuel was measured. At −20° C., the density was 816 kg/m³, the viscosity was 3.75 mPa·s (cP), and the dynamic viscosity was 4.58 mm²/s (cSt). The maximum allowable dynamic viscosity at −20° C. is 8 mm²/s (cSt). All of the tested parameters passed the detailed requirements for a semi-synthetic Jet A-1 as described by the ASTM D7566-18a standard specification for aviation turbine fuel containing synthesized hydrocarbons.

The flash point temperature of 50.0° C. (minimum 38° C. required) and density of 790.7 kg/m³ (minimum 775 kg/m³ required), indicated that additional lower boiling material could be accommodated in the semi-synthetic jet fuel blend. The onset of freezing point of −56.3° C. (maximum −47° C. required), density of 790.7 kg/m³ (maximum 840 kg/m³ required), smoke point of 23.0 mm (minimum 18 mm required), and final boiling point temperature of 261.0° C. (maximum 300° C. required), indicated that additional higher boiling material could accommodated in the semi-synthetic jet fuel blend.

TABLE 4
Semi-synthetic jet fuel characterization and comparison to the Jet A-1 specifications.

| | | | Semi- | | | |
|---|---|---|---|---|---|---|
| | | | synthetic | Jet A-1 specification | | Pass/ |
| Property evaluated | Test method | Units | jet fuel | minimum | maximum | Fail |
| Copper corrosion, classification | ASTM D130 | | no. 1a | — | no. 1 | pass |
| Aromatics | ASTM D1319 | volume % | 10.2 | 8 | 25 | pass |
| Smoke point | ASTM D1322 | mm | 23.0 | 18 | — | pass |
| Naphthalene content | ASTM D1840 | volume % | 0.21 | — | 3.0 | pass |
| Electrical conductivity | ASTM D2624 | pS/m² | 460 | 50 | 600 | pass |
| Mercaptan sulfur | ASTM D3227 | mass % | <0.0003 | — | 0.003 | pass |
| Thermal oxidation stability, pressure drop | ASTM D3241 | mm Hg | 0.1 | — | 25 | pass |
| Thermal oxidation stability, visual | ASTM D3241 | | <1 | — | 3 | pass |
| deposit rating | | | | | | |
| Tube deposit (ETR), average over 2.5 mm² | ASTM D3241 | nm | 10 | — | 85 | pass |
| Acid number | ASTM D3242 | mg KOH/g | 0.004 | — | 0.10 | pass |
| Net heat of combustion (corrected for sulfur) | ASTM D3338 | MJ/kg | 43.525 | 42.8 | — | pass |
| Water separation characteristics, MSEP-A | ASTM D3948 | | 72 | 70 | | pass |
| Density @ 15° C. | ASTM D4052 | kg/m³ | 790.7 | 775 | 840 | pass |
| Wear scar diameter | ASTM D5001 | mm | 0.65 | — | 0.85 | pass |
| Total sulfur | ASTM D5453 | mg/kg | 3.6 | — | 3000 | pass |
| Corrected flash point | ASTM D56 | ° C. | 50 | 38 | — | pass |
| Freezing point | ASTM D5972 | ° C. | −56.3 | — | −47 | pass |
| Distillation 10% recovered (corr) | ASTM D86 | ° C. | 180.9 | — | 205 | pass |
| Distillation 50% recovered (corr) | ASTM D86 | ° C. | 202.4 | report | report | pass |
| Distillation 90% recovered (corr) | ASTM D86 | ° C. | 238.4 | report | report | pass |
| Distillation final boiling point | ASTM D86 | ° C. | 261.0 | — | 300 | pass |
| Distillation residue | ASTM D86 | % | 1.2 | — | 1.5 | pass |
| Distillation loss | ASTM D86 | % | 0.2 | — | 1.5 | pass |
| Existent gum content | IP 540 | mg/100 mL | <1 | — | 7 | pass |

Example 5. The process as described herein is also capable of producing a fully synthetic jet fuel blend. Unlike a semi-synthetic jet fuel, fully synthetic jet fuel has no petroleum-derived blend component in the jet fuel blend.

A fully synthetic jet fuel was blended using products described in Examples 2 and 3. The blend consisted of 40 wt % of the 160-260° C. fraction of the hydrotreated oligomerization product shown in Table 2, and 60 wt % of the 160-240° C. fraction of the hydrocracked product shown in Table 3. This fully synthetic jet fuel was characterized and compared to Jet A-1 specification requirements (Table 5). A fuels laboratory performed the characterization, and added 1 mg/L Stadis 450 to the fully synthetic jet fuel before characterization.

In addition to those specifications listed in Table 5, the cold flow density and viscosity of the fully synthetic jet fuel was measured. At −20° C., the density was 812 kg/m³, the viscosity was 3.27 mPa·s (cP), and the dynamic viscosity was 4.02 mm²/s (cSt). The maximum allowable dynamic viscosity at −20° C. is 8 mm²/s (cSt). For those analyses that were performed, the fully synthetic jet fuel passed the requirements for synthetic Jet A-1 as described by the ASTM D7566-18a standard specification for aviation turbine fuel containing synthesized hydrocarbons.

The T₅₀−T₁₀=(197.8−181.7)=16.1° C., which is larger than the minimum difference of 15° C. required for a fully synthetic jet fuel. The T₉₀−T₁₀=41.1° C., which is larger than the minimum difference of 40° C. required for a fully synthetic jet fuel. The flash point temperature of 47.0° C. (minimum 38° C. required) and density of 786.1 kg/m³ (minimum 775 kg/m³ required), indicated that additional lower boiling material could accommodated in the fully synthetic jet fuel blend. The onset of freezing point of −72.2° C. (maximum −47° C. required), density of 786.1 kg/m³ (maximum 840 kg/m³ required), smoke point of 24.0 mm (minimum 18 mm required), and final boiling point temperature of 242.9° C. (maximum 300° C. required), indicated that additional higher boiling material could accommodated in the fully synthetic jet fuel blend.

TABLE 5
Fully synthetic jet fuel characterization and comparison to the Jet A-1 specifications.

| | | | Semi- | | | |
|---|---|---|---|---|---|---|
| | | | synthetic | Jet A-1 specification | | Pass/ |
| Property evaluated | Test method | Units | jet fuel | minimum | maximum | Fail |
| Copper corrosion, classification | ASTM D130 | | no. 1b | — | no. 1 | pass |
| Aromatics | ASTM D1319 | volume % | 10.4 | 8 | 25 | pass |
| Smoke point | ASTM D1322 | mm | 24.0 | 18 | — | pass |
| Naphthalene content | ASTM D1840 | volume % | 0.04 | — | 3.0 | pass |
| Electrical conductivity | ASTM D2624 | pS/m² | 543 | 50 | 600 | pass |
| Mercaptan sulfur | ASTM D3227 | mass % | <0.0003 | — | 0.003 | pass |
| Acid number | ASTM D3242 | mg KOH/g | 0.005 | — | 0.10 | pass |
| Net heat of combustion (corrected for sulfur) | ASTM D3338 | MJ/kg | 43.547 | 42.8 | — | pass |
| Water separation characteristics, MSEP-A | ASTM D3948 | | 97 | 70 | | pass |
| Density @ 15° C. | ASTM D4052 | kg/m³ | 786.1 | 775 | 840 | pass |
| Wear scar diameter | ASTM D5001 | mm | 0.62 | — | 0.85 | pass |
| Total sulfur | ASTM D5453 | mg/kg | 1.0 | — | 3000 | pass |
| Corrected flash point | ASTM D56 | ° C. | 47.0 | 38 | — | pass |
| Freezing point | ASTM D5972 | ° C. | −72.2 | — | −47 | pass |
| Distillation 10% recovered (corr) | ASTM D86 | ° C. | 181.7 | — | 205 | pass |
| Distillation 50% recovered (corr) | ASTM D86 | ° C. | 197.8 | report | report | pass |
| Distillation 90% recovered (corr) | ASTM D86 | ° C. | 222.8 | report | report | pass |
| Distillation final boiling point | ASTM D86 | ° C. | 242.9 | — | 300 | pass |
| Distillation residue | ASTM D86 | % | 1.2 | — | 1.5 | pass |
| Distillation loss | ASTM D86 | % | 0.4 | — | 1.5 | pass |
| Existent gum content | IP 540 | mg/100 mL | <1 | — | 7 | pass |

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A process for producing synthetic jet fuel, comprising
converting feedstock to synthesis gas;
converting the synthesis gas into a mixture comprising liquid hydrocarbons;
refining the mixture comprising liquid hydrocarbons to isolate a kerosene product; and
hydrotreating the kerosene product to form synthetic jet fuel.

2. The process of claim 1, wherein converting feedstock to synthesis gas comprises: pyrolyzing the feedstock under aqueous conditions to form a mixture comprising biocrude.

3. The process of claim 2, wherein the feedstock comprises biomass, organic materials, waste streams, or a combination thereof with a high water content.

4. The process of claim 1, wherein converting feedstock to synthesis gas comprises: pyrolyzing the feedstock to form a mixture comprising biocrude.

5. The process of claim 4, wherein the feedstock comprises biomass, organic materials, waste streams, or a combination thereof with a low water content.

6. The process of any one of claims 1 to 5, wherein converting feedstock to synthesis gas further comprises:
gasifying the mixture comprising biocrude to form the synthesis gas.

7. The process of claim 6, wherein gasifying the mixture comprising biocrude comprises:
supercritical water gasification of the mixture comprising biocrude to form a mixture comprising CH₄, CO, CO₂, and H₂; and
reforming the mixture comprising CH₄, CO, CO₂, and H₂ to form the synthesis gas.

8. The process of claim 7, wherein reforming comprises dry reformation and steam reformation.

9. The process of any one of claims 6 to 8, wherein when converting feedstock to synthesis gas, the process further comprises:
adding an oil feedstock, a sugar feedstock, and/or an alcohol feedstock to the mixture comprising biocrude before gasifying.

10. The process of any one of claims 1 to 9, wherein the synthesis gas comprises a H₂ to CO ratio that is less than 2 to 1.

11. The process of any one of claims 1 to 10, wherein the synthesis gas comprises a stoichiometric ratio of (H₂—CO₂)/(CO+CO₂) that is less than 2 to 1.

12. The process of any one of claims 1 to 11, wherein the synthesis gas comprises a Ribblet ratio of (H₂)/(2CO+3CO₂) that is less than 1 to 1.

13. The process of any one of claims 1 to 12, wherein converting the synthesis gas into a mixture comprising liquid hydrocarbons comprises:
performing a Fischer-Tropsch synthesis to convert the synthesis gas into a mixture comprising liquid hydrocarbons.

14. The process of claim 13, wherein the Fischer-Tropsch synthesis is performed with an iron-based catalyst.

15. The process of claim 14, wherein when performing the Fischer-Tropsch synthesis to convert the synthesis gas into a mixture comprising liquid hydrocarbons, the process further comprises:
a water-gas shift reaction to increase concentration of H₂.

16. The process of any one of claims 13 to 15, wherein the Fischer-Tropsch synthesis is performed at a pressure of approximately 2 MPa; or approximately 2.5 MPa; or approximately 2.8 MPa.

17. The process of any one of claims 13 to 15, wherein the Fischer-Tropsch synthesis is performed at a pressure in a range of about 1.5 MPa to 5 MPa; or in a range of about 2 MPa to about 4 MPa; or in a range of about 2 MPa to about 3 MPa; or in a range of about 1.5 to about 2.5 MPs; or in a range of about 2 MPa to about 2.5 MPa.

18. The process of any one of claims 13 to 15, wherein the Fischer-Tropsch synthesis is performed at a pressure of greater than 2 MPa.

19. The process of any one of claims 13 to 18, wherein the mixture comprising liquid hydrocarbons comprises an alkene to alkane ratio that is great than 1 to 1.

20. The process of any one of claims 1 to 19, wherein refining the mixture comprising liquid hydrocarbons to isolate a kerosene product comprises:
performing a vapour-liquid equilibrium separation on the mixture comprising liquid hydrocarbons; and
separating the mixture into the kerosene product and at least one of an aqueous product, a naphtha and gas product, or a gas oil and heavier product.

21. The process of claim 20, wherein the vapour-liquid equilibrium separation is performed as a single-stage separation and/or a multi-stage separation.

22. The process of claim 20 or 21, wherein, when an aqueous product is separated, refining the mixture comprising liquid hydrocarbons to isolate a kerosene product further comprises:
adding the separated aqueous product to the mixture comprising biocrude before gasifying the mixture comprising biocrude when converting feedstock to synthesis gas.

23. The process of any one of claims 20 to 22, wherein, when a naphtha and gas product is separated, refining the mixture comprising liquid hydrocarbons to isolate a kerosene product further comprises:
oligomerizing the naphtha and gas product to form a mixture comprising a first additional kerosene product.

24. The process of claim 23, wherein oligomerizing the naphtha and gas product is performed at a pressure of approximately 2.5 MPa; or approximately 2 MPa.

25. The process of claim 23, wherein oligomerizing the naphtha and gas product is performed at a pressure in a range of about 1.5 MPa to 3 MPa; or in a range of about 1.5 MPa to about 2.5 MPa; or in a range of about 2 MPa to about 2.5 MPa.

26. The process of any one of claims 23 to 25, wherein oligomerizing the naphtha and gas product is performed with a non-sulfided catalyst

27. The process of claim 26, wherein oligomerizing the naphtha and gas product is performed with an acidic ZSM-5 zeolite catalyst.

28. The process of any one of claims 23 to 27, wherein the first additional kerosene product comprises alkene and aromatic compounds.

29. The process of claim 28, wherein the first additional kerosene product comprises approximately 0% to approximately 60% aromatic compounds; approximately 1% to approximately 60% aromatic compounds; or approximately 1% to approximately 50% aromatic compounds; or approximately 1% to approximately 40% aromatic compounds; or approximately 1% to approximately 30% aromatic compounds; or approximately 0% to approximately 1% aromatic compounds; or approximately 1% to approximately 7% aromatic compounds; or approximately 8% to approximately 25% aromatic compounds; or approximately 8% aromatic compounds.

30. The process of any one of claims 20 to 29, wherein, when a gas oil and heavier product is separated, refining the mixture comprising liquid hydrocarbons to isolate a kerosene product further comprises:
hydrocracking the gas oil and heavier product to form a mixture comprising a second additional kerosene product.

31. The process of claim 30, wherein hydrocracking the gas oil and heavier product is performed at a pressure of approximately 2.5 MPa; or approximately 2 MPa.

32. The process of claim 30, wherein hydrocracking the gas oil and heavier product is performed at a pressure in a range of about 1.5 MPa to 3 MPa; or in a range of about 1.5 MPa to about 2.5 MPa; or in a range of about 2 MPa to about 2.5 MPa.

33. The process of any one of claims 30 to 32, wherein hydrocracking the gas oil and heavier product is performed with a non-sulfided catalyst

34. The process of any one of claims 30 to 33, wherein the hydrocracking is performed with a noble metal catalyst supported on amorphous silica-alumina.

35. The process of claim 34, wherein the catalyst is Pt/SiO₂—Al₂O₃.

36. The process of any one of claims 1 to 35, wherein hydrotreating the kerosene product to form synthetic jet fuel comprises:
hydrotreating the kerosene product, and
when a naphtha and gas product is separated, hydrotreating the first additional kerosene product,
to form a mixture comprising paraffinic hydrocarbons; and
fractionating the mixture comprising paraffinic hydrocarbons, and
when a gas oil and heavier product is separated, fractionating the mixture comprising the second additional kerosene product,
to isolate the synthetic jet fuel.

37. The process of claim 36, wherein when fractionating the mixture comprising paraffinic hydrocarbons and fractionating the mixture comprising the second additional kerosene product, the process further comprises:
adding the mixture comprising the second additional kerosene product to the mixture comprising paraffinic hydrocarbons before fractionating.

38. The process of claim 36 or 37, wherein each of the kerosene product, the first additional kerosene product, and the second additional kerosene product have a normal boiling point temperature range of about 140° C. to about 300° C.

39. The process of any one of claims 36 to 38, wherein the hydrotreating is performed at a pressure of approximately 2.5 MPa; or approximately 2 MPa.

40. The process of any one of claims 36 to 38, wherein the hydrotreating is performed at a pressure in a range of about 1.5 MPa to 3 MPa; or in a range of about 1.5 MPa to about 2.5 MPa; or in a range of about 2 MPa to about 2.5 MPa.

41. The process of any one of claims 36 to 40, wherein the hydrotreating is performed with a non-sulfided catalyst

42. The process of any one of claims 36 to 41, wherein the hydrotreating is performed with a reduced base metal catalyst supported on alumina or silica.

43. The process of claim 42, wherein the catalyst is reduced Ni/Al₂O₃.

44. The process of any one of claims 1 to 43, wherein the synthetic jet fuel is a semi-synthetic jet fuel, a fully synthetic jet fuel, or a combination thereof.
